(19) United States
(12) Patent Application Publication
(10) Pub. No.: US 2025/0224557 A1
(43) Pub. Date: Jul. 10, 2025

(54) SEMICONDUCTOR PHOTONICS DEVICES AND METHODS OF FORMATION

(71) Applicant: Taiwan Semiconductor Manufacturing Company, Ltd., Hsinchu (TW)

(72) Inventors: Chih-Tsung SHIH, Hsinchu City (TW); Sheng Kai YEH, Taichung City (TW); Chi-Yuan SHIH, Zhubei (TW)

(21) Appl. No.: 18/658,212

(22) Filed: May 8, 2024

Related U.S. Application Data
(60) Provisional application No. 63/617,940, filed on Jan. 5, 2024.

(51) Int. Cl. G02B 6/12

(52) U.S. Cl. CPC G02B 6/12004; G02B 2006/12097; G02B 2006/12173

(57) ABSTRACT

A semiconductor photonics device includes an optical waveguide structure having a top view size and/or shape that enables a particular optical signal loss to be achieved for the closed-loop optical waveguide structure. The optical waveguide structure may be manufactured to have a polygonal top view shape in which the optical waveguide structure includes a plurality of segments. The optical waveguide structure may be manufactured to have a particular radius, to have a particular quantity of segments, and/or to have another attribute such that a particular optical signal loss is achieved for the optical waveguide structure. This enables a Q factor for the optical waveguide structure to be balanced with a power coupling coefficient for the optical waveguide structure. This enables the optical waveguide structure to achieve critical coupling (or to achieve near-critical coupling).

### CROSS-REFERENCE TO RELATED APPLICATION

This patent application claims priority to Unites States Provisional Patent Application No. 63/617,940, filed on Jan. 5, 2024, and entitled “SEMICONDUCTOR PHOTONICS DEVICES AND METHODS OF FORMATION.” The disclosure of the prior application is considered part of and is incorporated by reference into this patent application.

### BACKGROUND

A semiconductor photonics device may be configured to use optical signals for high speed and secure data transmission between integrated circuits and/or semiconductor dies of the semiconductor photonics device. An optical signal may be transferred through a waveguide in the semiconductor photonics device. The waveguide enables confinement of the optical signal, which may reduce optical loss and increase propagation efficiency for the optical signal. Data may be encoded into an optical signal by modulating light into optical pulses through an optical modulator. The optical pulses are then transferred to the waveguide for propagation to other regions of the semiconductor photonics device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A and 1B are diagrams of example implementations of an example semiconductor photonics device described herein.

FIGS. 2A-2C are diagrams of example implementations of an example semiconductor photonics device described herein.

FIGS. 3A-3C are diagrams of example implementations of an example semiconductor photonics device described herein.

FIGS. 4A-4C are diagrams of example implementations of an example semiconductor photonics device described herein.

FIGS. 5A-5D are diagrams of example implementations of an example semiconductor photonics device described herein.

FIGS. 6A and 6B are diagrams of example implementations of an example semiconductor photonics device described herein.

FIGS. 7A-7F are diagrams of an example implementation of forming a semiconductor photonics device (or a portion thereof) described herein.

FIGS. 8A-8E are diagrams of an example implementation of forming a semiconductor photonics device (or a portion thereof) described herein.

FIGS. 9A-9E are diagrams of an example implementation of forming a semiconductor photonics device (or a portion thereof) described herein.

FIGS. 10A-10C are diagrams of example implementations of cross-sectional profiles for one or more waveguide structures described herein.

FIG. 11 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some cases, a photonic integrated circuit of a semiconductor photonics device may include one or more waveguide structures. For example, an approximately straight input/output waveguide structure (which may be referred to as a bus optical waveguide) may couple an optical signal to a ring-shaped waveguide structure, which may be used for filtering (e.g., wavelength filtering) or modulating the optical signal. In some cases, optical signal loss can occur as optical signals propagate around the ring-shaped waveguide structure, as well as when optical signals are coupled to and/or from the ring-shaped waveguide structure. Optical signal loss in a ring-shaped waveguide structure (intrinsic loss) may affect the quality factor (Q factor) of the ring-shaped waveguide structure. Optical signal loss from coupling (external coupling loss) also affects a power coupling coefficient (κ value) of the ring-shaped waveguide structure. The power coupling coefficient is an indication of an efficiency of optical signal coupling between the ring-shaped waveguide structure and the bus optical waveguide. If external coupling loss (which reduces the power coupling coefficient) and intrinsic loss (which reduces the Q factor) are not controlled, the ring-shaped waveguide structure may not operate efficiently and/or may not effectively filter with high selectivity.

For example, when the external coupling loss is greater than the intrinsic loss, the ring-shaped waveguide structure and the associated input/output waveguide structure may become under-coupled, resulting in insufficient optical power transfer from the input/output waveguide structure to the ring-shaped waveguide structure for modulation and/or filtering to occur. Conversely, when the intrinsic loss is greater than the external coupling loss, the ring-shaped waveguide structure and the associated input/output waveguide structure may become over-coupled, resulting in interference in the ring-shaped waveguide structure (which can cause nonlinear effects and/or other modulation defects) and excessive power consumption in the ring-shaped waveguide structure.

Some implementations described herein provide techniques and apparatuses for a semiconductor photonics device that includes a closed-loop optical waveguide structure having a top view size and/or shape that is configured to achieve a particular optical signal loss (intrinsic loss) for the closed-loop optical waveguide structure. The closed-loop optical waveguide structure may be manufactured to have a polygonal top view shape (such as an approximately octagonal top view shape or an approximately hexagonal top view shape, among other examples) in which the closed-loop optical waveguide structure includes a plurality of segments. The closed-loop optical waveguide structure may be manufactured to have a particular radius, to have a particular quantity of segments, and/or to have another attribute such that a particular optical signal loss is achieved for the closed-loop optical waveguide structure.

Manufacturing the closed-loop optical waveguide structure to have a particular optical signal loss enables the Q factor for the closed-loop optical waveguide structure to be balanced with the power coupling coefficient for the closed-loop optical waveguide structure. This enables the closed-loop optical waveguide structure to achieve critical coupling (or to achieve near-critical coupling), which is a condition where external coupling loss for the closed-loop optical waveguide structure and the optical signal loss for the closed-loop optical waveguide structure are approximately equal. At or near critical coupling, efficient operation (e.g., modulation or filtering with minimal modulation defects and reduced power consumption) and optical filtering with high selectivity can be achieved for the closed-loop optical waveguide structure relative to over-coupling or under-coupling.

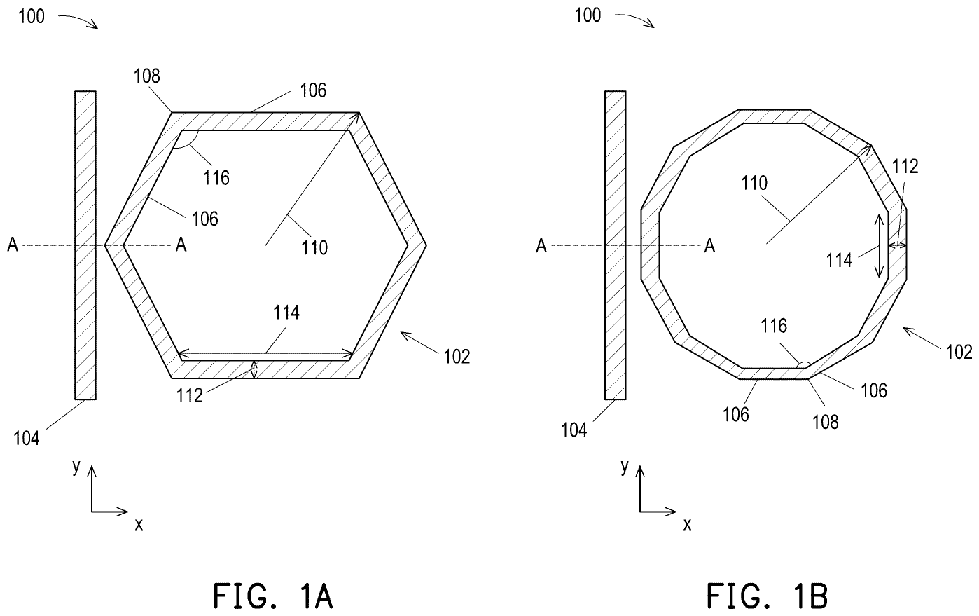

FIGS. 1A and 1B are diagrams of example implementations of an example semiconductor photonics device 100 described herein. The semiconductor photonics device 100 includes one or more photonic integrated circuits. Each of FIGS. 1A and 1B illustrates a top view of an example semiconductor photonics device 100. The semiconductor photonics device 100 may be configured to use optical signals for high speed and secure data transmission between integrated circuits and/or semiconductor dies of the semiconductor photonics device 100. Accordingly, the semiconductor photonics device 100 may include a closed-loop optical waveguide structure 102 and a bus optical waveguide structure 104. An optical signal may be transferred through the bus optical waveguide structure 104 in the semiconductor photonics device 100. The bus optical waveguide structure 104 enables confinement of the optical signal, which may reduce optical loss and increase propagation efficiency for the optical signal. Data may be encoded into an optical signal by modulating light into optical pulses in the closed-loop optical waveguide structure 102. The optical pulses are then transferred to the bus optical waveguide structure 104 for propagation to other regions of the semiconductor photonics device 100. Alternatively, particular wavelengths of the optical signal may be filtered in the closed-loop optical waveguide structure 102 such that the filtered wavelengths (or non-filtered wavelengths) are transferred back to the bus optical waveguide structure 104 for signal propagation.

The closed-loop optical waveguide structure 102 and the bus optical waveguide structure 104 may be adjacent and/or side-by-side in the semiconductor photonics device 100 to enable coupling of the optical signal from the closed-loop optical waveguide structure 102 to the bus optical waveguide structure 104 (and vice-versa for demodulation of an optical signal). As an example, and as shown in FIGS. 1A and 1B, the closed-loop optical waveguide structure 102 and the bus optical waveguide structure 104 may be horizontally adjacent (or laterally adjacent) in the x-direction semiconductor photonics device 100. The bus optical waveguide structure 104 extends in the y-direction along a side of the closed-loop optical waveguide structure 102.

The closed-loop optical waveguide structure 102 is “closed-loop” in that the structure of the closed-loop optical waveguide structure 102 is a continuous waveguide structure that connects to itself with no end points. This is different from other types of modulators and resonators such as Mach-Zender modulators (MZMs) that have end points corresponding to an input and an output. Instead of optical signals being coupled to and from an MZM through propagation of the optical signals through the input and output of the MZM, optical signals are coupled to and from the closed-loop optical waveguide structure 102 through evanescent coupling. Evanescent coupling from the bus optical waveguide structure 104 and the closed-loop optical waveguide structure 102 occurs when the evanescent field of the optical signals propagating through the bus optical waveguide structure 104 extends into the portion of the closed-loop optical waveguide structure 102 that is adjacent to the bus optical waveguide structure 104. Similarly, evanescent coupling from the closed-loop optical waveguide structure 102 to the bus optical waveguide structure 104 occurs when the evanescent field of the optical signals propagating through the closed-loop optical waveguide structure 102 extends into the portion of the bus optical waveguide structure 104.

Optical signal loss occurs in the closed-loop optical waveguide structure 102 as optical signals propagate around the closed-loop optical waveguide structure 102. Optical signal loss in the closed-loop optical waveguide structure 102 (intrinsic loss) may affect the Q factor of the closed-loop optical waveguide structure 102. In some cases, the Q factor may be expressed as the ratio λ_{cen}/λ_{FWHM}, where λ_{cen} is a central wavelength of the optical signal propagating around the closed-loop optical waveguide structure 102 and λ_{FWHM} is a full width at half maximum of the optical signal. The full width at half maximum is a function of the intrinsic loss and corresponds to a bandwidth of the optical signal in which a transmittance (e.g., loss) in the closed-loop optical waveguide structure 102 is less than-3 decibels (dB).

Optical signal loss also occurs when optical signals are coupled between the closed-loop optical waveguide structure 102 and the bus optical waveguide structure 104. Optical signal loss from coupling (external coupling loss) affects a power coupling coefficient (κ value) of the closed-loop optical waveguide structure 102. The power coupling coefficient is an indication of an efficiency of optical signal coupling between the closed-loop optical waveguide structure 102 and the bus optical waveguide structure 104. In some cases, the power coupling coefficient may be expressed as κ=1−exp(−2πRα), where R is a radius 110 of the closed-loop optical waveguide structure 102 and a represents the external coupling loss in units of decibels per centimeter (dB/cm).

If the external coupling loss α (which reduces the power coupling coefficient) and intrinsic loss (which affects λ_{FWHM} and thereby reduces the Q factor) are not controlled, the closed-loop optical waveguide structure 102 may not operate efficiently and/or may not effectively filter with high selectivity. For example, when the external coupling loss is greater than the intrinsic loss, the closed-loop optical waveguide structure 102 and the associated bus optical waveguide structure 104 may become under-coupled, resulting in insufficient optical power transfer from the bus optical waveguide structure 104 to the closed-loop optical waveguide structure 102 for modulation and/or filtering. Conversely, when the intrinsic loss is greater than the external coupling loss, the closed-loop optical waveguide structure 102 and the associated bus optical waveguide structure 104 may become over-coupled, resulting in interference in the closed-loop optical waveguide structure 102 (which can cause nonlinear effects and/or other modulation defects) and excessive power consumption in the closed-loop optical waveguide structure 102.

One of the primary contributors to intrinsic loss in a closed-loop optical waveguide structure is bending loss. “Bending loss” refers to optical loss that occurs because of the closed-loop shape of the closed-loop optical waveguide structure. In particular, when an optical signal encounters a bend in the closed-loop optical waveguide structure, optical loss occurs because of absorption of some of the optical signal when the optical signal interacts with the sidewalls of the closed-loop optical waveguide structure in the bend. Bending loss is typically inversely related to the radius of the closed-loop optical waveguide structure. The lesser the radius, the greater the bending loss (because the radius of curvature of the bends in the closed-loop optical waveguide structure is smaller), and the greater the radius, the lesser the bending loss. However, the resonant frequencies of the closed-loop optical waveguide structure are also dependent on the radius. Thus, the closed-loop optical waveguide structure may not be able to be manufactured to have a particular radius to achieve a particular intrinsic loss, because a different radius may be needed for modulation and/or filtering of particular wavelengths of the optical signals that are to be processed by the closed-loop optical waveguide structure. As a result, critical coupling may not be able to be achieved for the closed-loop optical waveguide structure.

As illustrated in FIGS. 1A and 1B, the closed-loop optical waveguide structure 102 includes a polygonal top view shape having a plurality of segments 106 that are coupled at intersection points 108. Adjacent segments 106 are coupled at adjoining ends of the adjacent segments 106 at an intersection point 108. Thus, each segment 106 is adjoined to two other segments 106 at opposing ends of the segment 106. In the example in FIG. 1A, an intersection point 108 is a portion of the closed-loop optical waveguide structure 102 that is closest to the bus optical waveguide structure 104. In the example in FIG. 1B, a segment 106 and the intersection points 108 at opposing ends of the segment 106 are closest to the bus optical waveguide structure 104.

The segments 106 of the closed-loop optical waveguide structure 102 introduce another type of loss, referred to as segment loss or segment-induced loss, that contributes to the intrinsic loss of the closed-loop optical waveguide structure 102. While the radius of the closed-loop optical waveguide structure 102 may not be able to be selected for tuning the intrinsic loss of the closed-loop optical waveguide structure 102 (e.g., because the radius may be based on achieving particular resonant frequencies for the closed-loop optical waveguide structure 102), the size, shape, and/or quantity of the segments 106 enables a particular segment-induced loss to be achieved for the closed-loop optical waveguide structure 102. Thus, the segment-induced loss enables the intrinsic loss of the closed-loop optical waveguide structure 102 to be tuned without adjusting the radius of the closed-loop optical waveguide structure 102, which enables a particular optical signal loss (intrinsic loss) for the closed-loop optical waveguide structure 102 to be achieved for achieving critical coupling.

FIGS. 1A and 1B illustrate some examples of polygonal top view shapes for the closed-loop optical waveguide structure 102. The closed-loop optical waveguide structure 102 may be manufactured to have a polygonal top view shape. For example, the closed-loop optical waveguide structure 102 may have an approximately hexagonal top view shape as shown in FIG. 1A with six (6) interconnected segments 106. As another example, the closed-loop optical waveguide structure 102 may have an approximately dodecagonal top view shape as shown in FIG. 1B with twelve (12) interconnected segments 106. However, other quantities of segments 106 are within the scope of the present disclosure. In particular, the closed-loop optical waveguide structure 102 may be manufactured to have a particular radius 110, to have a particular quantity of segments 106, to have a particular width 112 of each segment 106, to have a particular length 114 of each segment 106, to have a particular angle 116 between adjacent segments 106, and/or to have another attribute such that a particular optical signal loss is achieved for the closed-loop optical waveguide structure 102. In some implementations, the quantity of segments 106, the length 114 of each segment 106, the angle 116 between adjacent segments 106, and/or another parameter of the closed-loop optical waveguide structure 102 may be selected to achieve a particular radius 110 for the closed-loop optical waveguide structure 102. In some implementations, the length 114 of each segment 106 and/or the angle 116 between adjacent segments 106 is based on the quantity of the segments 106 included in the closed-loop optical waveguide structure 102.

Moreover, in the examples illustrated in FIGS. 1A and 1B, the widths 112 of the each of the segments 106 are approximately equal, the lengths 114 of each of the segments 106 are approximately equal, and the angles between adjacent segments 106 are approximately equal. In other examples illustrated and described herein, the widths 112 of two or more segments 106 of a closed-loop optical waveguide structure 102 are different widths, the lengths 114 of two or more segments 106 of a closed-loop optical waveguide structure 102 are different lengths, and/or the angles 116 between two or sets of segments 106 of a closed-loop optical waveguide structure 102 are different angles.

Segment-induced loss occurs at the intersection points 108 between segments 106 as optical signals transition between the segments 106 of the closed-loop optical waveguide structure 102. In particular, the change in propagation direction that occurs at an intersection point 108 between adjacent segments 106 results in the segment-induced loss in the optical signals. The segment-induced loss increases as the quantity of the segments 106 decreases. In other words, a lesser quantity of segments 106 results in greater segment-induced loss than a greater quantity of segments 106 for the same radius 110, because the angle 116 between adjacent segments 106 is less for fewer segments 106 (resulting in sharper changes in direction for optical signals in the closed-loop optical waveguide structure 102) than for a greater quantity of segments 106. Thus, the closed-loop optical waveguide structure 102 of FIG. 1A, which has a hexagonal top view shape, has a greater segment-induced loss for a given radius 110 than the closed-loop optical waveguide structure 102 of FIG. 1B, which has a dodecagonal top view shape. Accordingly, the closed-loop optical waveguide structure 102 may be manufactured to have the example polygonal top view shape illustrated in FIG. 1A in a case when the external coupling loss between the closed-loop optical waveguide structure 102 and the bus optical waveguide structure 104 is greater, or may be manufactured to have the example polygonal top view shape illustrated in FIG. 1B when the external coupling loss is less.

In some implementations, a closed-loop optical waveguide structure 102 with a fixed quantity of segments 106 may have a greater segment-induced loss (e.g., a greater amount of loss per segment) if the closed-loop optical waveguide structure 102 is manufactured with a greater radius 110, as the length 114 of each segment 106 increases as the radius 110 increases. Thus, the quantity of segments selected for the closed-loop optical waveguide structure 102 may be based on the radius 110 of the closed-loop optical waveguide structure 102, as well as the intrinsic loss that is to be achieved for the closed-loop optical waveguide structure 102. In some implementations, the segment-induced loss (e.g., a greater amount of loss per segment) for a closed-loop optical waveguide structure 102 with a fixed quantity of segments 106 may decrease up to a particular radius size and may increase as the radius is increased past the particular radius size.

In this way, manufacturing the closed-loop optical waveguide structure 102 to have a particular optical signal loss (e.g., intrinsic loss) by controlling parameters of the closed-loop optical waveguide structure 102 (e.g., the radius 110, the quantity of segments 106, the length 114 of segments 106, among others) enables the closed-loop optical waveguide structure 102 to achieve critical coupling (or to achieve near-critical coupling). When the closed-loop optical waveguide structure 102 is at or near the critical coupling condition, an extinction ratio (measured in dB) of the closed-loop optical waveguide structure 102 may be greater relative to the over-coupling condition or the under-coupling condition. The extinction ratio of the closed-loop optical waveguide structure 102 represents a difference between the transmittance (in dB) at λ_{cen}, the central wavelength of the optical signal, and the transmittance (in dB) at a wavelength at half maximum of the optical signal. In some cases, when the closed-loop optical waveguide structure 102 is at or near the critical coupling condition, the extinction ratio may approach infinity.

Accordingly, manufacturing the closed-loop optical waveguide structure 102 to have a particular optical signal loss (e.g., intrinsic loss) enables the Q factor for the closed-loop optical waveguide structure 102 to be balanced with the power coupling coefficient for the closed-loop optical waveguide structure 102, which enables the closed-loop optical waveguide structure 102 to achieve critical or near-critical coupling. At or near critical coupling, efficient operation (e.g., modulation or filtering with minimal modulation defects and reduced power consumption) and optical filtering with high selectivity can be achieved for the closed-loop optical waveguide structure 102, relative to over-coupling or under-coupling.

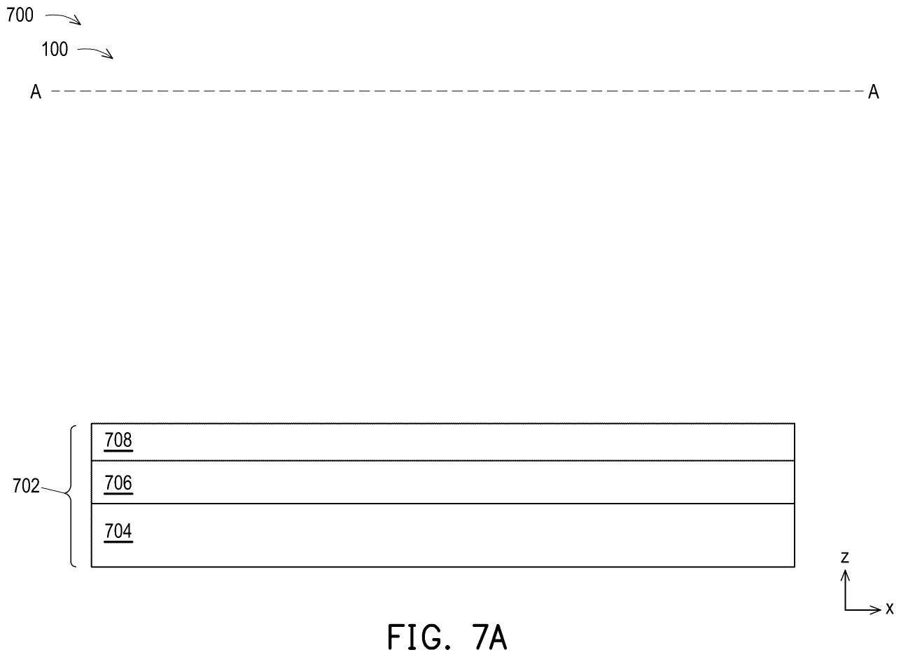

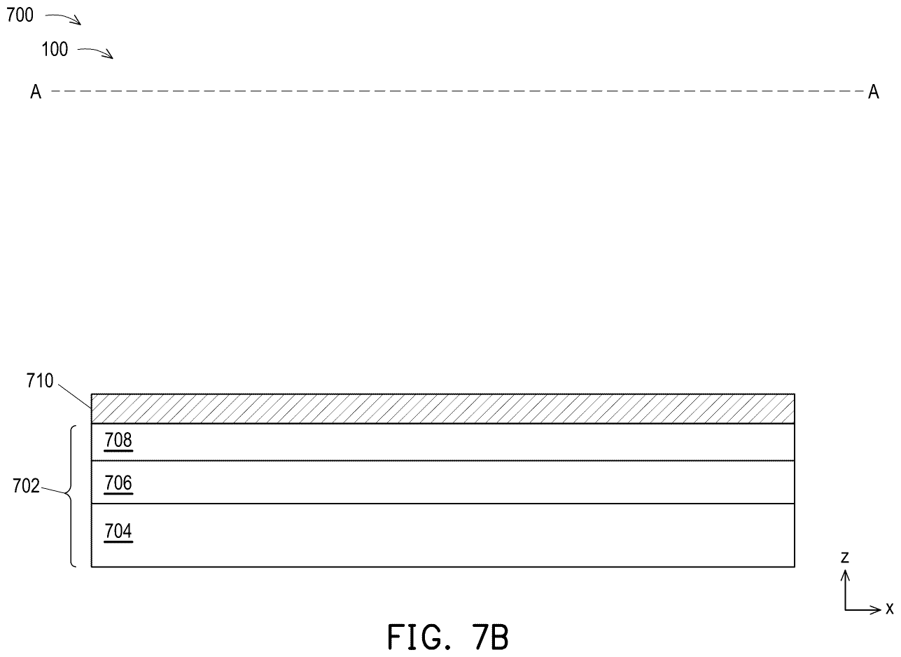

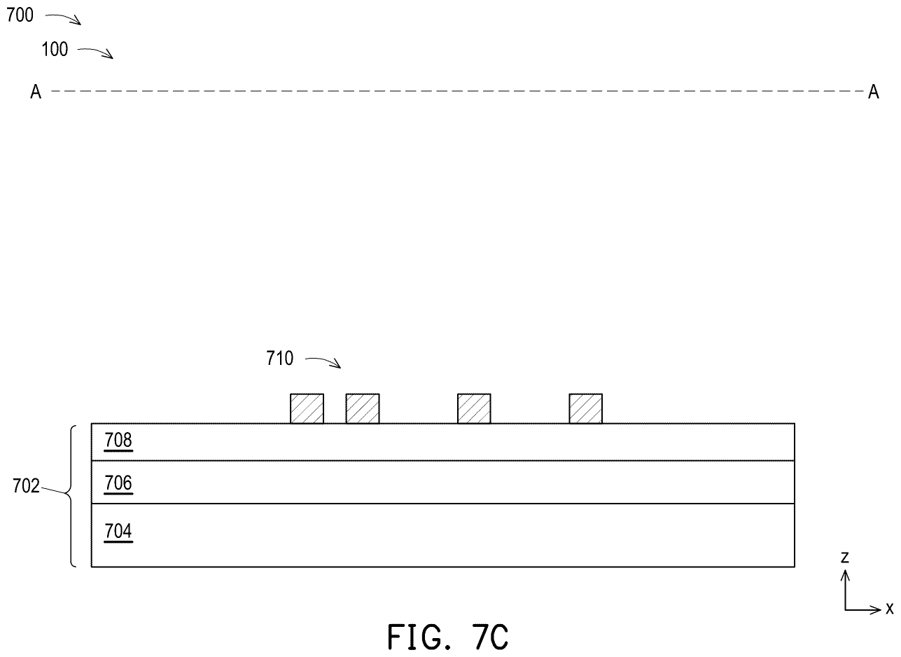

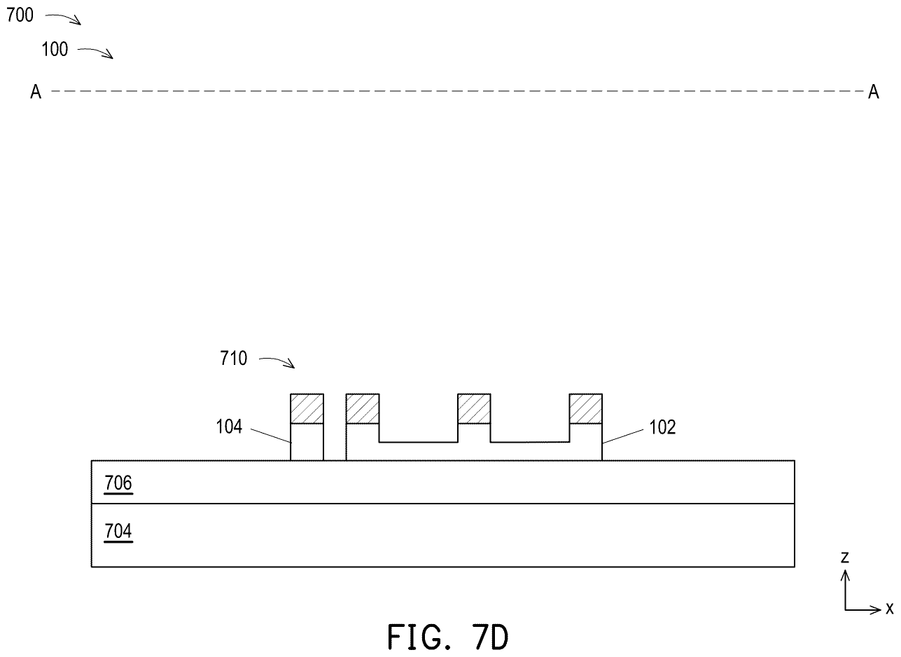

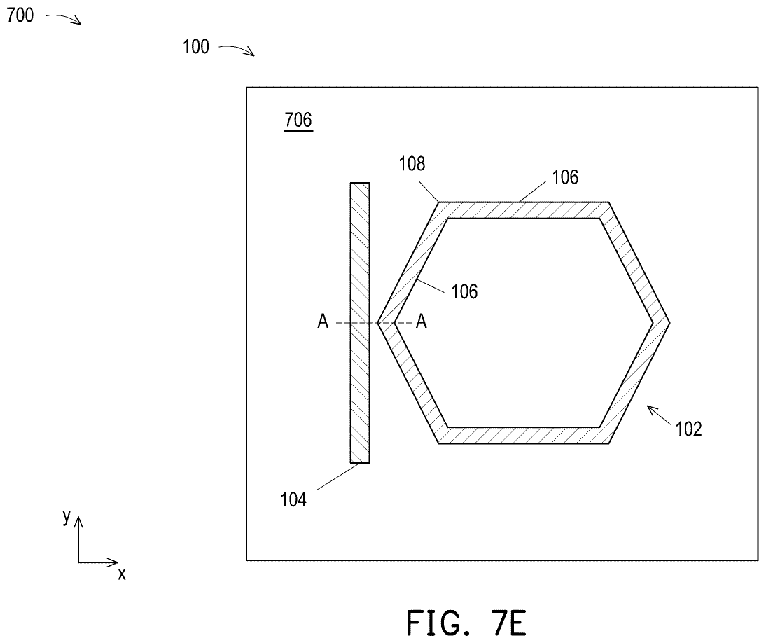

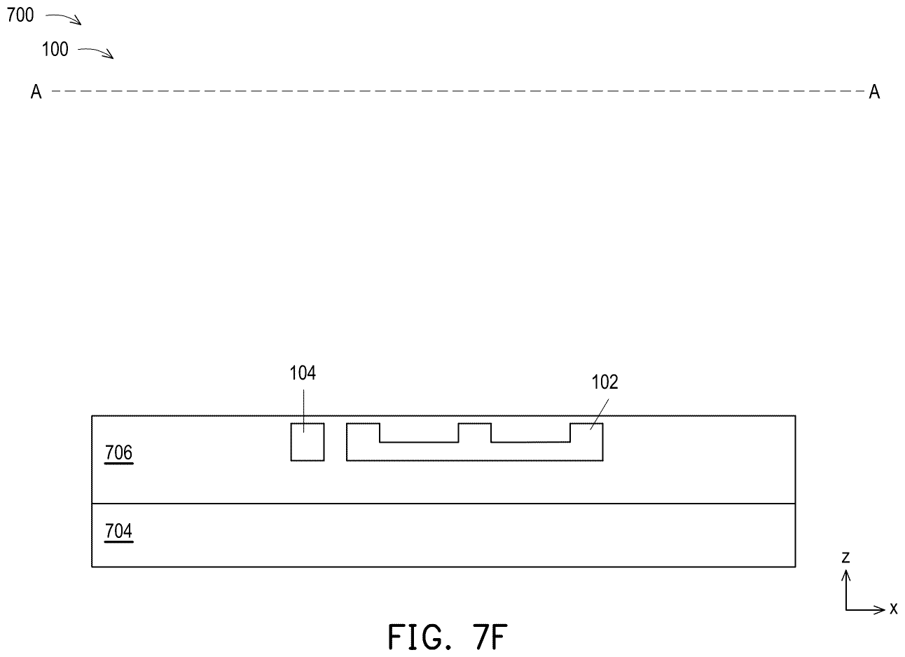

FIGS. 1A and 1B further illustrate a location of cross-sectional views that are illustrated in other figures included herein. For example, cross-sectional views in FIGS. 7A-7F, 8A-8E, 9A-9F, and/or 10A-10C, among other examples, are illustrated along a line A-A in the x-direction across the bus optical waveguide structure 104 and the adjacent closed-loop optical waveguide structure 102.

As indicated above, FIGS. 1A and 1B are provided as examples. Other examples may differ from what is described with regard to FIGS. 1A and 1B.

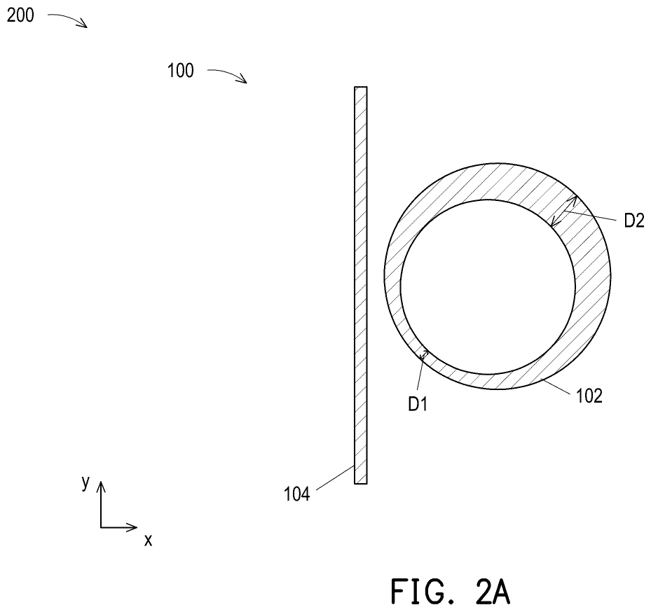

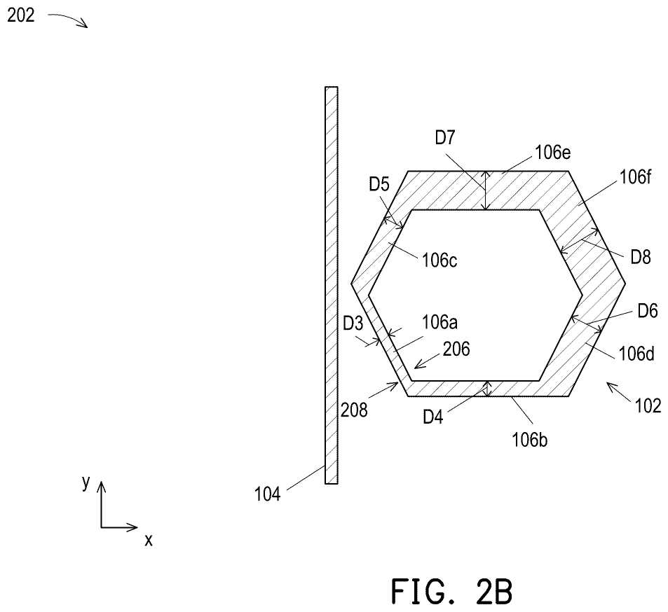

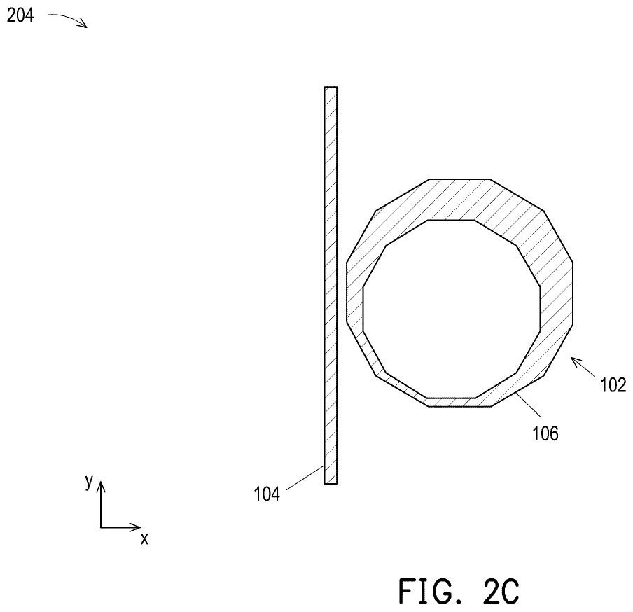

FIGS. 2A-2C are diagrams of example implementations of an example semiconductor photonics device 100 described herein. The example implementations of the semiconductor photonics device 100 illustrated and described in connection with FIGS. 2A-2C are similar to those illustrated and described connection with FIGS. 1A and 1B, except that the example implementations of the semiconductor photonics device 100 illustrated and described in connection with FIGS. 2A-2C each include a closed-loop optical waveguide structure 102 that has one or more non-uniform features. This enables tuning of intrinsic loss of the closed-loop optical waveguide structure 102 that is alternative to, or in addition to, the intrinsic loss tuning through the inclusion of segments 106 in the closed-loop optical waveguide structure 102.

As shown in an example implementation 200 of the semiconductor photonics device 100 in FIG. 2A, a closed-loop optical waveguide structure 102 of the semiconductor photonics device 100 may be ring-shaped (e.g., may be non-segmented). A first side of the closed-loop optical waveguide structure 102 has a first width (dimension D1 in FIG. 2A), and a second side of the closed-loop optical waveguide structure 102 opposing the first side has a second width (dimension D2) that is greater than the first width. The width of the closed-loop optical waveguide structure 102 increases (e.g., gradually and/or uniformly) around the closed-loop optical waveguide structure 102 from the first width at the first side to the second width at the second side.

FIG. 2B illustrates an example implementation 202 of the semiconductor photonics device 100, and FIG. 2C illustrates an example implementation 204 of the semiconductor photonics device 100, both of which include a closed-loop optical waveguide structure 102 having a polygonal top view shape that includes a plurality of segments 106 that are connected at intersection points 108 at opposing ends of the segments 106. As shown in FIGS. 2B and 2C, two or more segments 106 of a closed-loop optical waveguide structure 102 may have different widths. Referred to FIG. 2B, for example, a closed-loop optical waveguide structure 102 may include a segment 106a having a first width (dimension D3), a segment 106b having a second width (dimension D4) that is greater than the first width, a segment 106c having a third width (dimension D5) that is greater than the second width, a segment 106d having a fourth width (dimension D6) that is greater than the third width, a segment 106e having a fifth width (dimension D7) that is greater than the fourth width, and/or a segment 106f having a sixth width (dimension D8) that is greater than the fifth width. The widths of the segments 106 may increase from the segment 106a to the segment 106f in one or more directions around the closed-loop optical waveguide structure 102. As another example, the widths for alternating segments 106 may increase around a closed-loop optical waveguide structure 102. For example, the third width of the segment 106c may be greater than the first width of the segment 106a, and the fifth width of the segment 106e may be greater than the third width of the segment 106c.

In some implementations, a segment 106 may have an inner sidewall and an outer sidewall that have different lengths in order to achieve segments 106 that have different lengths. For example, and referring again to FIG. 2B, the segment 106a may have an inner sidewall 206 and an outer sidewall 208, where the length of the outer sidewall 208 is greater than the length of the inner sidewall 206. This enables the segment 106b and/or the segment 106c, adjoined to the segment 106a, to have widths that are different than the width of the segment 106a.

Additionally and/or alternatively, two or more segments of a closed-loop optical waveguide structure 102 may have different lengths. Additionally and/or alternatively, the angles between two or more pairs of adjoined segments 106 of a closed-loop optical waveguide structure 102 may be different angles. Additionally and/or alternatively, two or more segments of a closed-loop optical waveguide structure 102 may have different thicknesses.

As indicated above, FIGS. 2A-2C are provided as examples. Other examples may differ from what is described with regard to FIGS. 2A-2C.

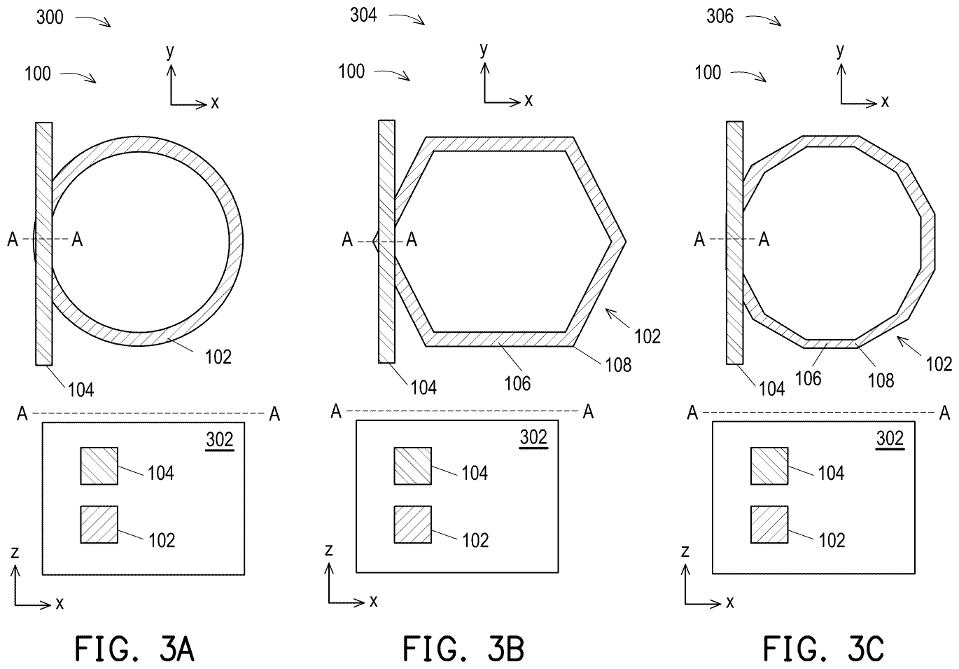

FIGS. 3A-3C are diagrams of example implementations of an example semiconductor photonics device 100 described herein. The example implementations of the semiconductor photonics device 100 illustrated and described in connection with FIGS. 3A-3C are similar to those illustrated and described connection with FIGS. 1A and 1B, except that the example implementations of the semiconductor photonics device 100 illustrated and described in connection with FIGS. 3A-3C each include a closed-loop optical waveguide structure 102 and a bus optical waveguide structure 104 that include different materials. This provides increased manufacturing flexibility for manufacturing the closed-loop optical waveguide structure 102 and the bus optical waveguide structure 104 as an alternative to, or in addition to, the intrinsic loss tuning through the inclusion of segments 106 in the closed-loop optical waveguide structure 102. Moreover, the closed-loop optical waveguide structure 102 and the bus optical waveguide structure 104 may be vertically arranged in the z-direction in the semiconductor photonics device 100, which reduces the lateral footprint of the photonic integrated circuit that includes the closed-loop optical waveguide structure 102 and the bus optical waveguide structure 104.

FIG. 3A illustrates a top view and an associated cross-section view along the line A-A for an example implementation 300 of the semiconductor photonics device 100. As shown in the top view in FIG. 3A, a closed-loop optical waveguide structure 102 of the semiconductor photonics device 100 may be ring-shaped (e.g., may be non-segmented). A bus optical waveguide structure 104 may be located over a portion of the closed-loop optical waveguide structure 102 such that the portion of the closed-loop optical waveguide structure 102 and the bus optical waveguide structure 104 are aligned in the x-direction in the semiconductor photonics device 100.

As shown in the cross-section view in FIG. 3A, the portion of the closed-loop optical waveguide structure 102 and the bus optical waveguide structure 104 may be vertically arranged in the z-direction in the semiconductor photonics device 100. The closed-loop optical waveguide structure 102 and the bus optical waveguide structure 104 may be included in a dielectric layer 302 in the semiconductor photonics device 100. The dielectric layer 302 may include one or more dielectric materials, such as a silicon oxide (SiOx), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material.

The closed-loop optical waveguide structure 102 and the bus optical waveguide structure 104 may include different materials or different material compositions. For example, the closed-loop optical waveguide structure 102 may include one or more semiconductor materials and the bus optical waveguide structure 104 may include one or more dielectric materials. As another example, the closed-loop optical waveguide structure 102 may include one or more dielectric materials and the bus optical waveguide structure 104 may include one or more semiconductor materials. Examples of such semiconductor materials include silicon (Si), germanium (Ge), silicon germanium (SiGe), silicon doped with one or more types of dopants (e.g., p-type dopants, n-type dopants), germanium doped with one or more times of dopants, and/or another semiconductor material. Examples of such dielectric materials include a silicon oxide (SiOₓ), a silicon nitride (SiₓN_{y}), a silicon oxide doped with one or more types of dopants, a silicon nitride doped with one or more types of dopants, and/or another dielectric material.

Additionally and/or alternatively, the closed-loop optical waveguide structure 102 and the bus optical waveguide structure 104 may have different widths. Additionally and/or alternatively, the closed-loop optical waveguide structure 102 and the bus optical waveguide structure 104 may have different thicknesses.

FIG. 3B illustrates an example implementation 304 of the semiconductor photonics device 100, and FIG. 3C illustrates an example implementation 306 of the semiconductor photonics device 100, both of which include a closed-loop optical waveguide structure 102 having a polygonal top view shape that includes a plurality of segments 106 that are connected at intersection points 108 at opposing ends of the segments 106. As shown in the top views in FIGS. 3B and 3C, a bus optical waveguide structure 104 may be located over a portion of a closed-loop optical waveguide structure 102 such that the portion of the closed-loop optical waveguide structure 102 and the bus optical waveguide structure 104 are aligned in the x-direction in the semiconductor photonics device 100. The portion of the closed-loop optical waveguide structure 102 may include one or more segments 106, one or more intersection points 108, or a combination thereof.

As indicated above, FIGS. 3A-3C are provided as examples. Other examples may differ from what is described with regard to FIGS. 3A-3C.

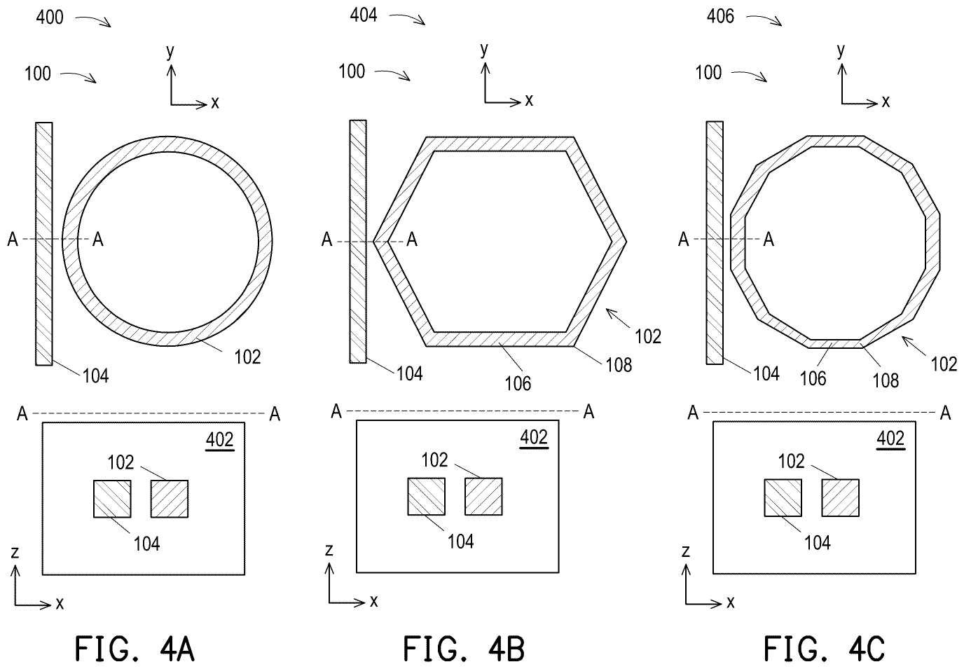

FIGS. 4A-4C are diagrams of example implementations of an example semiconductor photonics device 100 described herein. The example implementations of the semiconductor photonics device 100 illustrated and described in connection with FIGS. 4A-4C are similar to those illustrated and described connection with FIGS. 1A and 1B, except that the example implementations of the semiconductor photonics device 100 illustrated and described in connection with FIGS. 4A-4C each include a closed-loop optical waveguide structure 102 and a bus optical waveguide structure 104 that include different materials. This provides increased manufacturing flexibility for manufacturing the closed-loop optical waveguide structure 102 and the bus optical waveguide structure 104 as an alternative to, or in addition to, the intrinsic loss tuning through the inclusion of segments 106 in the closed-loop optical waveguide structure 102. Moreover, the closed-loop optical waveguide structure 102 and the bus optical waveguide structure 104 may be horizontally arranged in the x-direction in the semiconductor photonics device 100, which reduces the vertical footprint of the photonic integrated circuit that includes the closed-loop optical waveguide structure 102 and the bus optical waveguide structure 104. Moreover, this enables a modulator heater structure to be included above the closed-loop optical waveguide structure 102 for stabilizing the resonant frequencies of the closed-loop optical waveguide structure 102.

FIG. 4A illustrates a top view and an associated cross-section view along the line A-A for an example implementation 400 of the semiconductor photonics device 100. As shown in the top view in FIG. 4A, a closed-loop optical waveguide structure 102 of the semiconductor photonics device 100 may be ring-shaped (e.g., may be non-segmented). A bus optical waveguide structure 104 may be located laterally adjacent to a portion of the closed-loop optical waveguide structure 102 such that the portion of the closed-loop optical waveguide structure 102 and the bus optical waveguide structure 104 are arranged in the x-direction and offset relative to each other in the y-direction.

As shown in the cross-section view in FIG. 4A, the portion of the closed-loop optical waveguide structure 102 and the bus optical waveguide structure 104 may be horizontally arranged in the x-direction in the semiconductor photonics device 100. The closed-loop optical waveguide structure 102 and the bus optical waveguide structure 104 may be included in a dielectric layer 402 in the semiconductor photonics device 100. The dielectric layer 402 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material.

The closed-loop optical waveguide structure 102 and the bus optical waveguide structure 104 may include different materials or different material compositions. For example, the closed-loop optical waveguide structure 102 may include one or more semiconductor materials and the bus optical waveguide structure 104 may include one or more dielectric materials. As another example, the closed-loop optical waveguide structure 102 may include one or more dielectric materials and the bus optical waveguide structure 104 may include one or more semiconductor materials. Examples of such semiconductor materials include silicon (Si), germanium (Ge), silicon germanium (SiGe), silicon doped with one or more types of dopants (e.g., p-type dopants, n-type dopants), germanium doped with one or more times of dopants, and/or another semiconductor material. Examples of such dielectric materials include a silicon oxide (SiOₓ), a silicon nitride (SiₓN_{y}), a silicon oxide doped with one or more types of dopants, a silicon nitride doped with one or more types of dopants, and/or another dielectric material.

Additionally and/or alternatively, the closed-loop optical waveguide structure 102 and the bus optical waveguide structure 104 may have different widths. Additionally and/or alternatively, the closed-loop optical waveguide structure 102 and the bus optical waveguide structure 104 may have different thicknesses.

FIG. 4B illustrates an example implementation 404 of the semiconductor photonics device 100 and FIG. 4C illustrates an example implementation 406 of the semiconductor photonics device 100, both of which include a closed-loop optical waveguide structure 102 having a polygonal top view shape that includes a plurality of segments 106 that are connected at intersection points 108 at opposing ends of the segments 106. As shown in the top views in FIGS. 4B and 4C, a bus optical waveguide structure 104 may be located laterally adjacent to a portion of a closed-loop optical waveguide structure 102 such that the portion of the closed-loop optical waveguide structure 102 and the bus optical waveguide structure 104 are arranged in the x-direction and offset relative to each other in the y-direction in the semiconductor photonics device 100. The portion of the closed-loop optical waveguide structure 102 may include one or more segments 106, one or more intersection points 108, or a combination thereof.

As indicated above, FIGS. 4A-4C are provided as examples. Other examples may differ from what is described with regard to FIGS. 4A-4C.

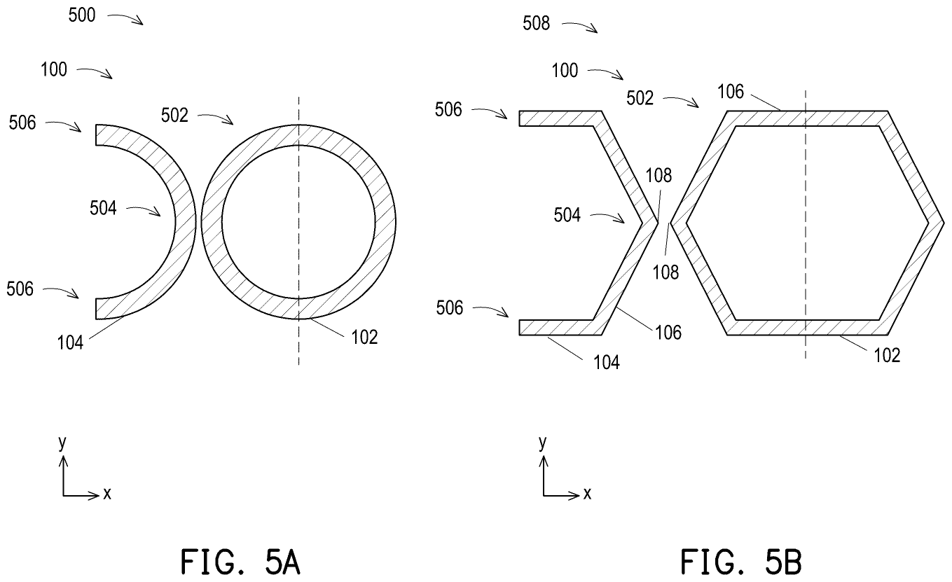

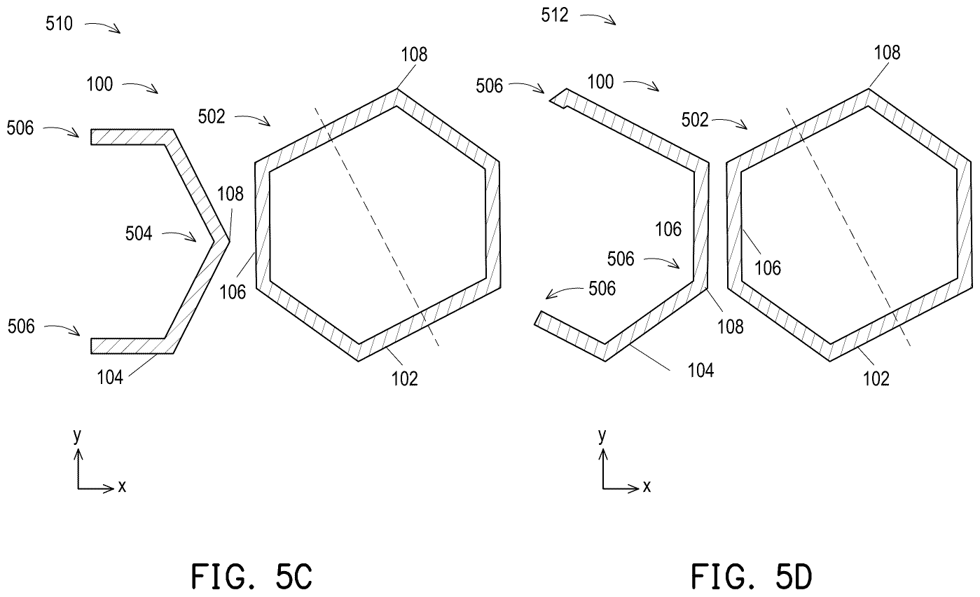

FIGS. 5A-5D are diagrams of example implementations of an example semiconductor photonics device 100 described herein. The example implementations of the semiconductor photonics device 100 illustrated and described in connection with FIGS. 5A-5D are similar to those illustrated and described connection with FIGS. 1A and 1B, except that the example implementations of the semiconductor photonics device 100 illustrated and described in connection with FIGS. 5A-5D each include a closed-loop optical waveguide structure 102 and a bus optical waveguide structure 104 that is symmetrical to at least a portion of the closed-loop optical waveguide structure 102. This enables the intrinsic loss in the bus optical waveguide structure 104 to be tuned in a similar manner as the intrinsic loss in the closed-loop optical waveguide structure 102.

FIG. 5A illustrates a top view of an example implementation 500 of the semiconductor photonics device 100. As shown in the top view in FIG. 5A, a closed-loop optical waveguide structure 102 of the semiconductor photonics device 100 may be ring-shaped (e.g., may be non-segmented). A bus optical waveguide structure 104 may be located laterally adjacent to the closed-loop optical waveguide structure 102. The bus optical waveguide structure 104 may have a top view shape that is symmetrical to, and mirrored relative to, a portion 502 of the closed-loop optical waveguide structure 102 facing the bus optical waveguide structure 104. For example, the bus optical waveguide structure 104 may have a semi-circle shape (or half-circle shape) that has a center point 504 adjacent to the closed-loop optical waveguide structure 102 and endpoints 506 facing away from the closed-loop optical waveguide structure 102. The bending loss in the bus optical waveguide structure 104 may be tuned by manufacturing the bus optical waveguide structure 104 to have a particular radius of curvature.

FIG. 5B illustrates a top view of an example implementation 508 of the semiconductor photonics device 100. As shown in the top view in FIG. 5B, the example implementation 508 is similar to the example implementation 500, except that the closed-loop optical waveguide structure 102 of the semiconductor photonics device 100 has a polygonal top view shape that includes a plurality of segments 106 that are adjoined at ends of the segments 106 at intersection points 108. Thus, the bus optical waveguide structure 104 also includes a plurality of segments 106 that are adjoined at ends of the segments 106 at intersection points 108. Moreover, in the example implementation 508 in FIG. 5B, the center point 504 of the bus optical waveguide structure 104 corresponds to an intersection point 108 that is adjacent to an intersection point 108 of the closed-loop optical waveguide structure 102.

FIG. 5C illustrates a top view of an example implementation 510 of the semiconductor photonics device 100. As shown in the top view in FIG. 5C, the example implementation 510 is similar to the example implementation 508 in FIG. 5B, except that the closed-loop optical waveguide structure 102 in the example implementation 510 in FIG. 5C is rotated relative to the closed-loop optical waveguide structure 102 in the example implementation 508 in FIG. 5B. As a result, the center point 504 of the bus optical waveguide structure 104, corresponding to an intersection point 108 between segments 106 of the bus optical waveguide structure 104, is adjacent to a segment 106 and the associated intersection points 108 at opposing ends of the segment 106 of the closed-loop optical waveguide structure 102.

FIG. 5D illustrates a top view of an example implementation 512 of the semiconductor photonics device 100. As shown in the top view in FIG. 5D, the example implementation 512 is similar to the example implementation 510 in FIG. 5C, except that the bus optical waveguide structure 104 is rotated relative to the bus optical waveguide structure 104 in the example implementation 510 in FIG. 5C. As a result, a segment 106 of the bus optical waveguide structure 104 is adjacent to a segment 106 of the closed-loop optical waveguide structure 102.

As indicated above, FIGS. 5A-5D are provided as examples. Other examples may differ from what is described with regard to FIGS. 5A-5D.

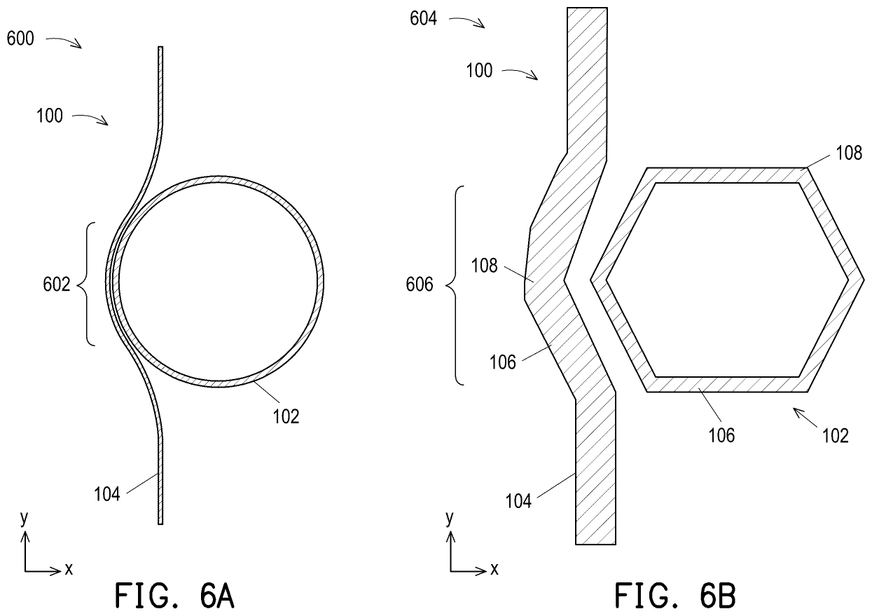

FIGS. 6A and 6B are diagrams of example implementations of an example semiconductor photonics device 100 described herein. The example implementations of the semiconductor photonics device 100 illustrated and described in connection with FIGS. 6A and 6B are similar to those illustrated and described connection with FIGS. 1A and 1B, except that the example implementations of the semiconductor photonics device 100 illustrated and described in connection with FIGS. 6A and 6B each include a closed-loop optical waveguide structure 102 and a bus optical waveguide structure 104 that has a section that conforms to the top view shape of the closed-loop optical waveguide structure 102. This section can be used to tune the intrinsic loss in the bus optical waveguide structure 104, in addition to (or alternative to) tuning the intrinsic loss in the closed-loop optical waveguide structure 102.

FIG. 6A illustrates a top view of an example implementation 500 of the semiconductor photonics device 100. As shown in the top view in FIG. 6A, a closed-loop optical waveguide structure 102 of the semiconductor photonics device 100 may be ring-shaped (e.g., may be non-segmented). A bus optical waveguide structure 104 may be located laterally adjacent to the closed-loop optical waveguide structure 102. The bus optical waveguide structure 104 may have a section 602 that conforms to the top view shape of a portion of the closed-loop optical waveguide structure 102 adjacent to the bus optical waveguide structure 104. For example, the section 602 of the bus optical waveguide structure 104 may have a semi-circle shape or curved shape adjacent to the closed-loop optical waveguide structure 102. The semi-circle shape of the section 602 conforms to (e.g., follows the curvature of) the portion of the closed-loop optical waveguide structure 102.

FIG. 6B illustrates a top view of an example implementation 604 of the semiconductor photonics device 100. As shown in the top view in FIG. 6B, the example implementation 604 is similar to the example implementation 600, except that the closed-loop optical waveguide structure 102 of the semiconductor photonics device 100 has a polygonal top view shape that includes a plurality of segments 106 that are adjoined at ends of the segments 106 at intersection points 108. Thus, a section 606 of the bus optical waveguide structure 104 adjacent to the closed-loop optical waveguide structure 102 also includes a plurality of segments 106 that are adjoined at ends of the segments 106 at an intersection point 108.

As indicated above, FIGS. 6A and 6B are provided as examples. Other examples may differ from what is described with regard to FIGS. 6A and 6B.

FIGS. 7A-7F are diagrams of an example implementation 700 of forming the semiconductor photonics device 100 (or a portion thereof) described herein. In some implementations, one or more of the semiconductor processing operations described in connection with the example implementation 700 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 700 may be performed to form one or more of the example implementations of the semiconductor photonics device 100 illustrated and described in connection with FIGS. 1A, 1B, 2A-2C, 5A-5D, 6A, and/or 6B, among other examples.

Turning to FIG. 7A, a substrate 702 may be provided. The substrate 702 may include a silicon on insulator (SOI) substrate that includes a semiconductor substrate 704 (e.g., a silicon (Si) substrate and/or another type of semiconductor substrate), a dielectric layer 706 (e.g., a buried oxide or bottom oxide (BOX) layer and/or another type of insulator layer) over and/or on the semiconductor substrate 704, and a semiconductor layer 708 (e.g., a silicon (Si) layer and/or another type of semiconductor layer) over and/or on the dielectric layer 706.

Alternatively, the semiconductor substrate 704 may be provided as a semiconductor wafer, and a deposition tool may be used to form the dielectric layer 706 over and/or on the semiconductor substrate 704, and may form the semiconductor layer 708 over and/or on the dielectric layer 706. A deposition tool may be used to form the dielectric layer 706 using a CVD technique, a PVD technique, an oxidation technique (e.g., a thermal oxidation technique), and/or another type of deposition technique. A deposition tool may be used to form the first semiconductor layer 708 using a CVD technique, a PVD technique, an epitaxy technique, and/or another type of deposition technique.

As shown in FIGS. 7B-7D, the bus optical waveguide structure 104 and the closed-loop optical waveguide structure 102 may be formed in the semiconductor layer 708. In some implementations, a pattern in a hard mask layer 710 is used to etch the semiconductor layer 708 to form the bus optical waveguide structure 104 and the closed-loop optical waveguide structure 102. As shown in FIG. 7B, a deposition tool may be used to form the hard mask layer 710 on the semiconductor layer 708 (e.g., using a CVD technique, a PVD technique, and/or another type of deposition technique).

As shown in FIG. 7C, the hard mask layer 710 may be patterned. The hard mask layer 710 may be patterned using a photoresist layer. A deposition tool may be used to form the photoresist layer on the hard mask layer 710 using a spin-coating technique and/or another type of deposition technique. An exposure tool may be used to expose the photoresist layer to a radiation source to form a pattern the photoresist layer. A developer tool may be used to develop and remove portions of the photoresist layer to expose the pattern. The pattern may be transferred to the hard mask layer 710 by etching the hard mask layer 710 based on the pattern in the photoresist layer.

As shown in FIG. 7D, an etch tool may be used to etch the semiconductor layer 708 to form the bus optical waveguide structure 104 and the closed-loop optical waveguide structure 102 by removing portions of the semiconductor layer 708 based on the pattern in the hard mask layer 710. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 710 using a chemical mechanical planarization (CMP) technique and/or another type of planarization technique.

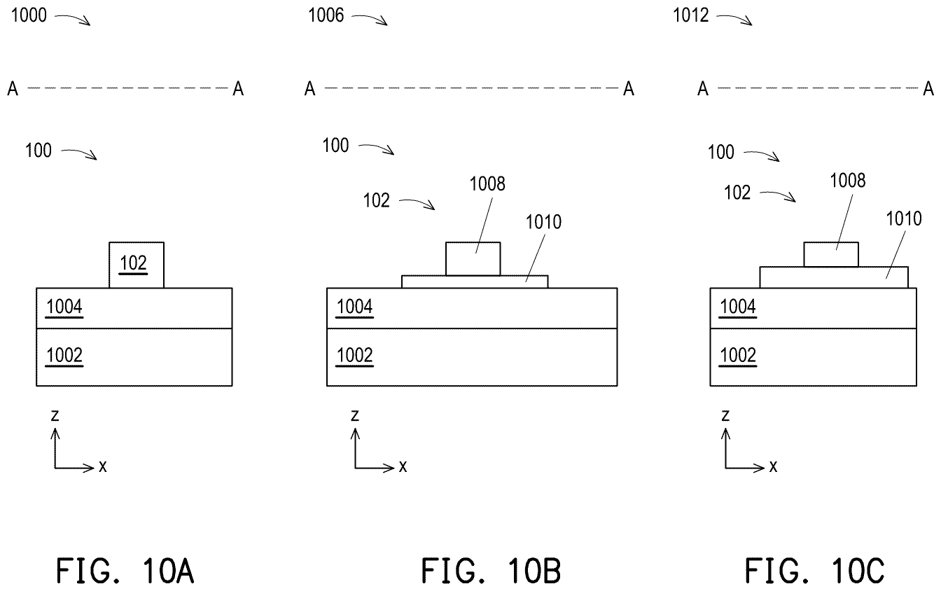

FIG. 7D further illustrates example cross-sectional profiles for the bus optical waveguide structure 104 and for the closed-loop optical waveguide structure 102. Alternative implementations for the bus optical waveguide structure 104 and/or for the closed-loop optical waveguide structure 102 are illustrated in connection with FIGS. 10A-10C. As shown, the bus optical waveguide structure 104 may be a strip waveguide that includes an approximate rectangular cross-section shape or an approximate square cross-section shape. The closed-loop optical waveguide structure 102 may also have a strip waveguide cross-sectional profile. Additionally, the closed-loop optical waveguide structure 102 may have terminals or contacts on opposing sides of the strip waveguide to enable voltages to be applied to the closed-loop optical waveguide structure 102 for modifying the refractive index of the closed-loop optical waveguide structure 102 for modulating optical signals.

As shown in a top view of the semiconductor photonics device 100 in FIG. 7E, the closed-loop optical waveguide structure 102 may be formed to have a polygonal top view shape having a plurality of segments 106, as illustrated in the example implementations of the closed-loop optical waveguide structure 102 in FIGS. 1A, 1B, 2A-2C, 5A-5D, 6A, and/or 6B, among other examples.

As shown in FIG. 7F, additional material for the dielectric layer 706 may be deposited to encapsulate the bus optical waveguide structure 104 and the closed-loop optical waveguide structure 102 in the dielectric layer 706. A deposition tool may be used to deposit the additional material for the dielectric layer 706 using a CVD technique, a PVD technique, an oxidation technique (e.g., a thermal oxidation technique), and/or another type of deposition technique. In some implementations, one or more additional semiconductor processing operations may be performed to deposit the additional material of the dielectric layer 706. For example, a deposition tool may be used to perform a shallow trench isolation (STI) liner oxidation operation and/or a high density plasma (HDP) deposition operation to deposit the additional material of the dielectric layer 706. As another example, a planarization tool may be used to perform a CMP operation and/or another type of planarization operation to planarize the dielectric layer 706 after the additional material of the dielectric layer 706 is deposited.

As indicated above, FIGS. 7A-7F are provided as an example. Other examples may differ from what is described with regard to FIGS. 7A-7F.

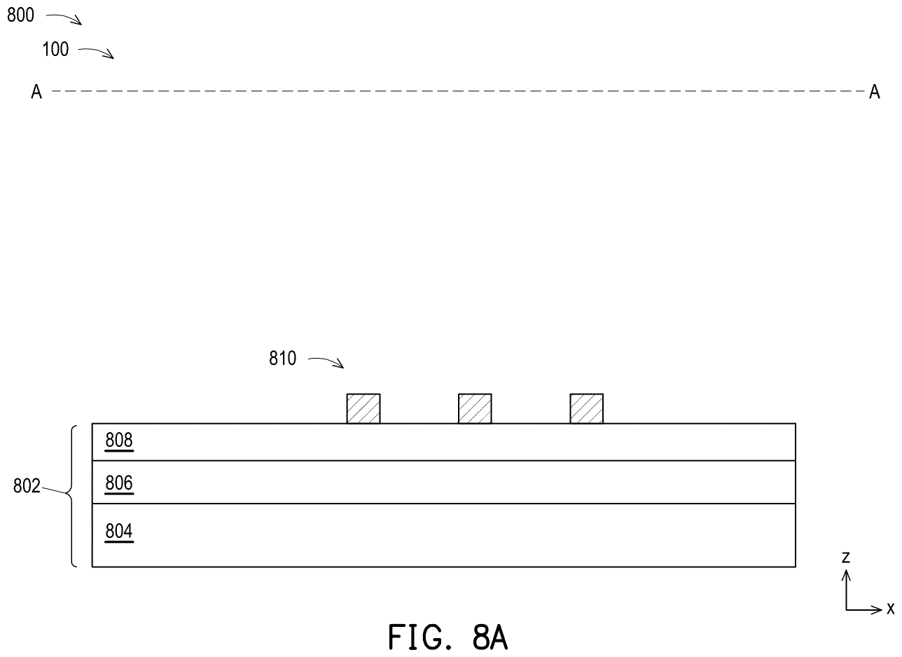

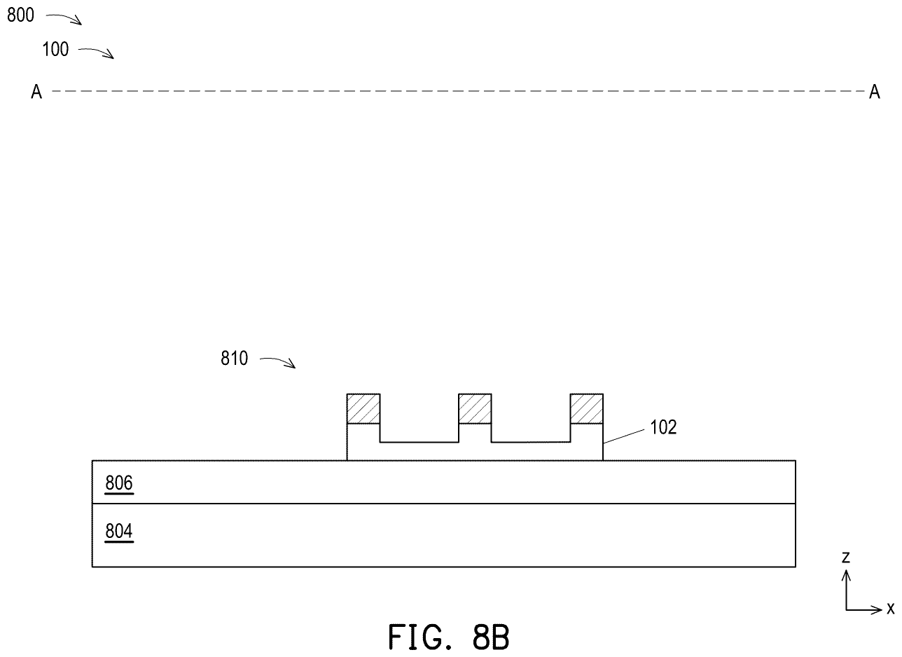

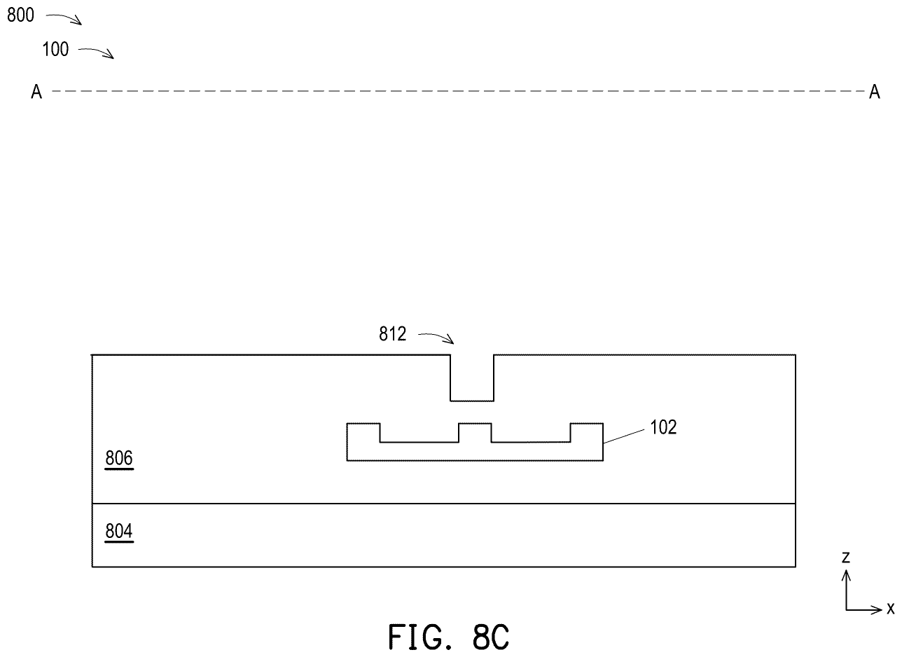

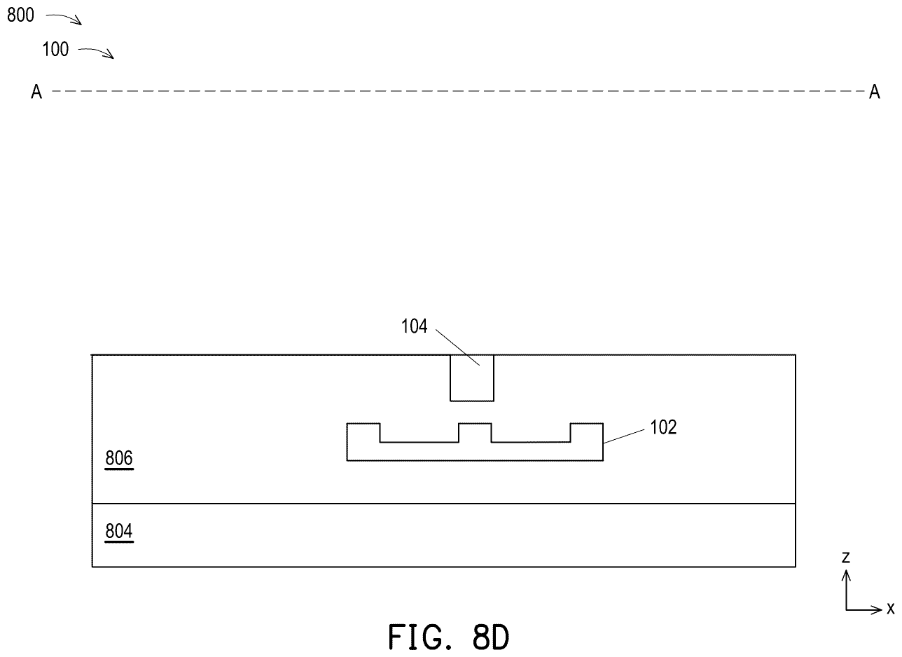

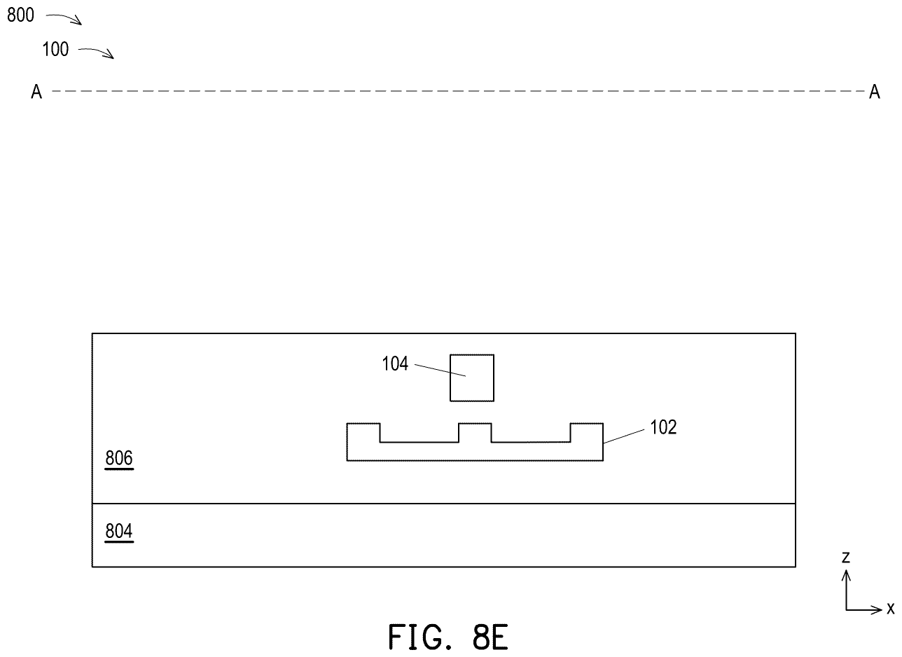

FIGS. 8A-8E are diagrams of an example implementation 800 of forming the semiconductor photonics device 100 (or a portion thereof) described herein. In some implementations, one or more of the semiconductor processing operations described in connection with the example implementation 800 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 800 may be performed to form one or more of the example implementations of the semiconductor photonics device 100 illustrated and described in connection with FIGS. 3A-3C, among other examples.

Turning to FIG. 8A, a substrate 802 may be provided. The substrate 802 may include a semiconductor substrate 804, a dielectric layer 806, and a semiconductor layer 808, similar to the substrate 702 in the example implementation 700. As further shown in FIG. 8A, a hard mask layer 810 may be formed on the semiconductor layer 808 and patterned similarly to the hard mask layer 710 in the example implementation 700. However, in the example implementation 800, the hard mask layer 810 is patterned for formation of only the closed-loop optical waveguide structure 102 and not for the bus optical waveguide structure 104.

As shown in FIG. 8B, an etch tool is used to etch the semiconductor layer 808 to form the closed-loop optical waveguide structure 102 by removing portions of the semiconductor layer 808 based on the pattern in the hard mask layer 810. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 810 using a CMP technique and/or another type of planarization technique. The closed-loop optical waveguide structure 102 may be formed to have a polygonal top view shape having a plurality of segments 106, as illustrated in the example implementations of the closed-loop optical waveguide structure 102 in FIGS. 1A, 1B, 2A-2C, 3A-3C, 5A-5D, 6A, and/or 6B, among other examples.

As shown in FIG. 8C, additional material for the dielectric layer 806 may be deposited to encapsulate the closed-loop optical waveguide structure 102 in the dielectric layer 806. A deposition tool may be used to deposit the additional material for the dielectric layer 806 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 806 after the additional material of the dielectric layer 806 is deposited.

As further shown in FIG. 8C, a recess 812 may be formed in the dielectric layer 806. The recess 812 is formed above the closed-loop optical waveguide structure 102 in the z-direction in the semiconductor photonics device 100. In some implementations, a pattern in a photoresist layer is used to etch the dielectric layer 806 to form the recess 812. In these implementations, a deposition tool may be used to form the photoresist layer on the dielectric layer 806. An exposure tool may be used to expose the photoresist layer to a radiation source to pattern the photoresist layer. A developer tool may be used to develop and remove portions of the photoresist layer to expose the pattern. An etch tool may be used to etch the dielectric layer 806 based on the pattern to form the recess 812 in the dielectric layer 806. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 806 based on a pattern.

As shown in FIG. 8D, dielectric material may be deposited in the recess 812 to form the bus optical waveguide structure 104 in the recess 812. A deposition tool may be used to deposit the dielectric material of the bus optical waveguide structure 104 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the bus optical waveguide structure 104 after the additional material of the dielectric material of the bus optical waveguide structure 104 is deposited.

As shown in FIG. 8E, additional material for the dielectric layer 806 may be deposited to encapsulate the bus optical waveguide structure 104 in the dielectric layer 806. A deposition tool may be used to deposit the additional material for the dielectric layer 806 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 806 after the additional material of the dielectric layer 06 is deposited.

As indicated above, FIGS. 8A-8E are provided as an example. Other examples may differ from what is described with regard to FIGS. 8A-8E.

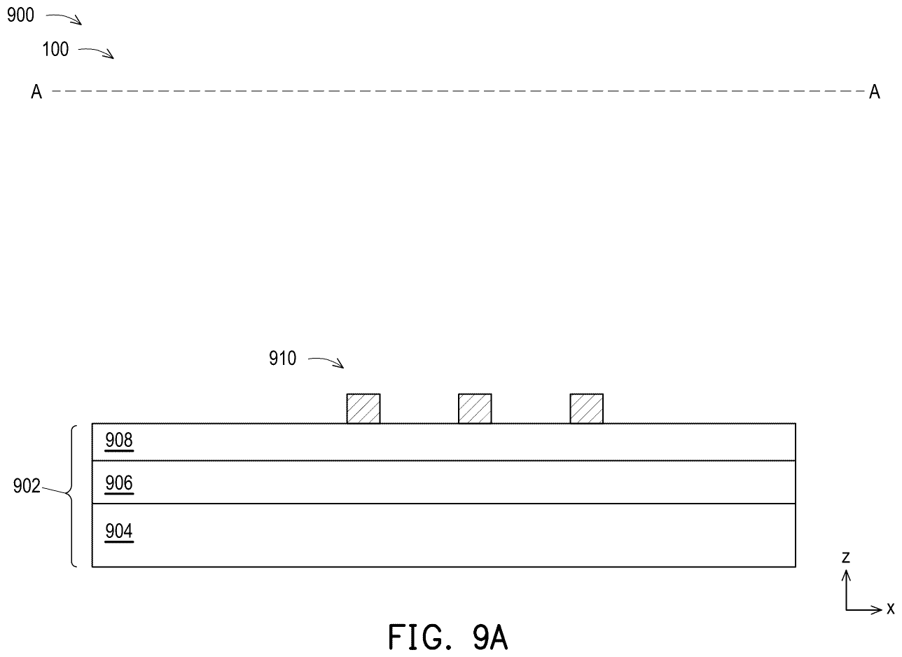

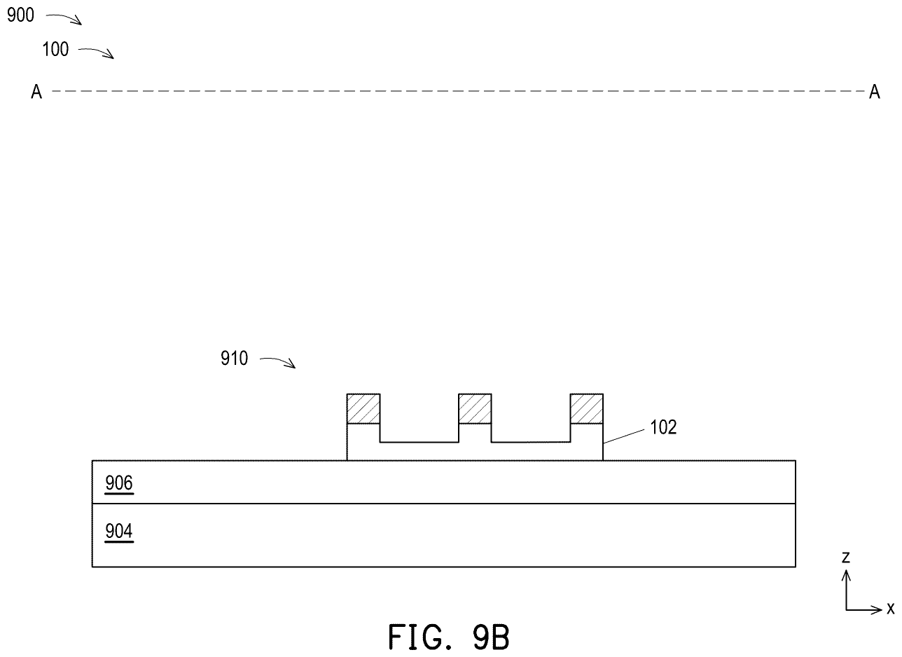

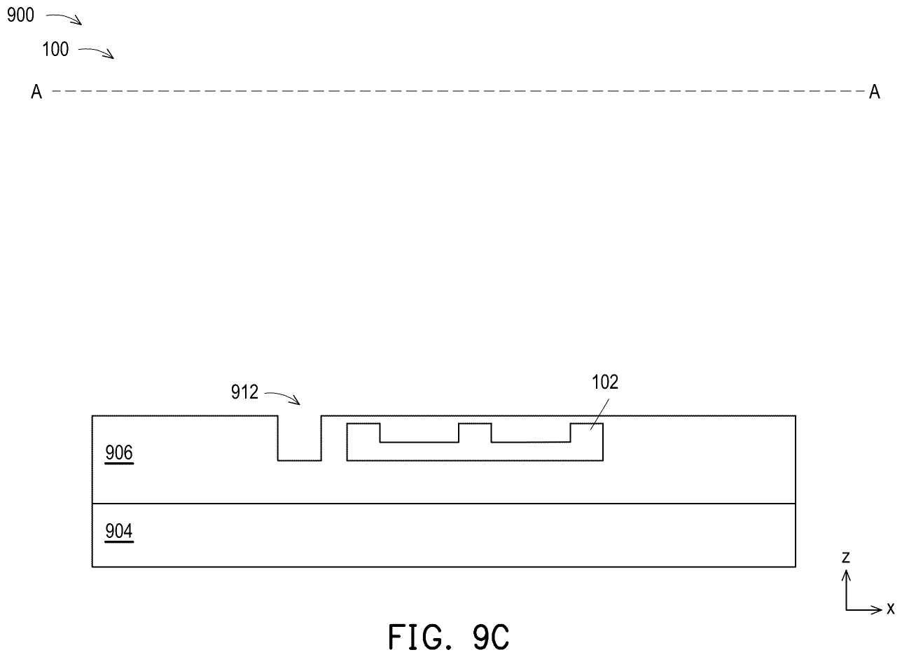

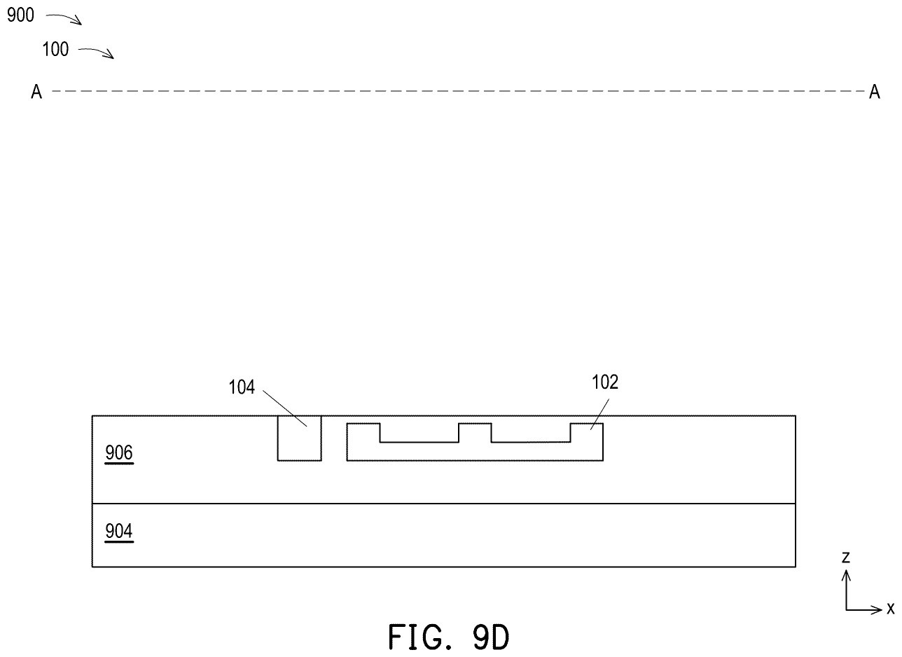

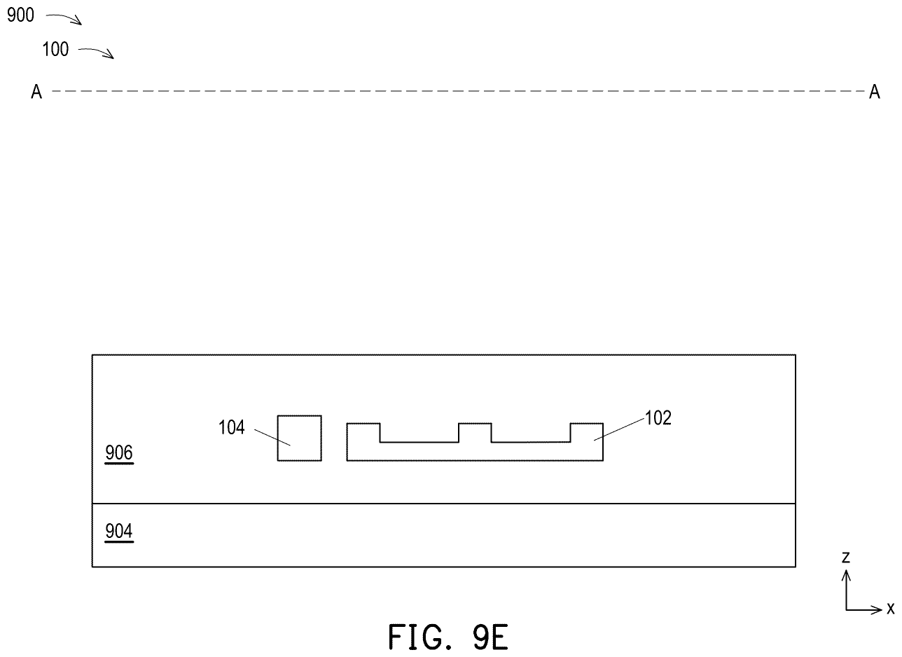

FIGS. 9A-9E are diagrams of an example implementation 900 of forming the semiconductor photonics device 100 (or a portion thereof) described herein. In some implementations, one or more of the semiconductor processing operations described in connection with the example implementation 900 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 900 may be performed to form one or more of the example implementations of the semiconductor photonics device 100 illustrated and described in connection with FIGS. 4A-4C, among other examples.

Turning to FIG. 9A, a substrate 902 may be provided. The substrate 902 may include a semiconductor substrate 904, a dielectric layer 906, and a semiconductor layer 908, similar to the substrate 702 in the example implementation 700. As further shown in FIG. 9A, a hard mask layer 910 may be formed on the semiconductor layer 908 and patterned similarly to the hard mask layer 710 in the example implementation 700. However, in the example implementation 900, the hard mask layer 910 is patterned for formation of only the closed-loop optical waveguide structure 102 and not for the bus optical waveguide structure 104.

As shown in FIG. 9B, an etch tool is used to etch the semiconductor layer 908 to form the closed-loop optical waveguide structure 102 by removing portions of the semiconductor layer 908 based on the pattern in the hard mask layer 910. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 910 using a CMP technique and/or another type of planarization technique. The closed-loop optical waveguide structure 102 may be formed to have a polygonal top view shape having a plurality of segments 106, as illustrated in the example implementations of the closed-loop optical waveguide structure 102 in FIGS. 1A, 1B, 2A-2C, 4A-4C, 5A-5D, 6A, and/or 6B, among other examples.

As shown in FIG. 9C, additional material for the dielectric layer 906 may be deposited to encapsulate the closed-loop optical waveguide structure 102 in the dielectric layer 906. A deposition tool may be used to deposit the additional material for the dielectric layer 906 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 906 after the additional material of the dielectric layer 806 is deposited.

As further shown in FIG. 9C, a recess 912 may be formed in the dielectric layer 906. The recess 912 is formed horizontally adjacent to the closed-loop optical waveguide structure 102 in the x-direction in the semiconductor photonics device 100. In some implementations, a pattern in a photoresist layer is used to etch the dielectric layer 906 to form the recess 912. In these implementations, a deposition tool may be used to form the photoresist layer on the dielectric layer 906. An exposure tool may be used to expose the photoresist layer to a radiation source to pattern the photoresist layer. A developer tool may be used to develop and remove portions of the photoresist layer to expose the pattern. An etch tool may be used to etch the dielectric layer 906 based on the pattern to form the recess 912 in the dielectric layer 906. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 906 based on a pattern.

As shown in FIG. 9D, dielectric material may be deposited in the recess 912 to form the bus optical waveguide structure 104 in the recess 912. A deposition tool may be used to deposit the dielectric material of the bus optical waveguide structure 104 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the bus optical waveguide structure 104 after the additional material of the dielectric material of the bus optical waveguide structure 104 is deposited.

As shown in FIG. 9E, additional material for the dielectric layer 906 may be deposited to encapsulate the bus optical waveguide structure 104 in the dielectric layer 906. A deposition tool may be used to deposit the additional material for the dielectric layer 906 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 906 after the additional material of the dielectric layer 906 is deposited.

As indicated above, FIGS. 9A-9E are provided as an example. Other examples may differ from what is described with regard to FIGS. 9A-9E.

FIGS. 10A-10C are diagrams of example implementations of cross-sectional profiles for one or more waveguide structures described herein. A closed-loop optical waveguide structure 102 described herein and/or a bus optical waveguide structure 104 described herein may be manufactured to have one or more of the example implementations of cross-sectional profiles illustrated in FIGS. 10A-10C. In some implementations, a closed-loop optical waveguide structure 102 described herein and/or a bus optical waveguide structure 104 described herein may be manufactured to have another cross-sectional profile.

FIG. 10A illustrates an example implementation 1000 of a cross-sectional profile of a closed-loop optical waveguide structure 102. The cross-sectional profile in FIG. 10A may be referred to as a strip waveguide. The strip waveguide has a square-shaped cross-sectional profile or a rectangle-shaped cross-sectional profile and includes a strip of semiconductor material or dielectric material. The strip waveguide may be formed above a semiconductor substrate 1002 (which may correspond to the semiconductor substrate 704, 804, and/or 904, among other examples) and on a dielectric layer 1004 (which may correspond to the dielectric layer 706, 806, and/or 906, among other examples).

FIG. 10B illustrates an example implementation 1006 of a cross-sectional profile of a closed-loop optical waveguide structure 102. The cross-sectional profile in FIG. 10B may be referred to as a rib waveguide. The rib waveguide includes a strip section 1008 on top of a planar section 1010, where the planar section extends laterally outward past the strip section 1008 in the x-direction on opposing sides of the strip section 1008.

FIG. 10C illustrates an example implementation 1012 of a cross-sectional profile of a closed-loop optical waveguide structure 102. The cross-sectional profile in FIG. 10C may be referred to as a deep rib waveguide. The deep rib waveguide includes a strip section 1008 on top of a planar section 1010, where the planar section extends laterally outward past the strip section 1008 in the x-direction on opposing sides of the strip section 1008. The difference between the deep rib waveguide cross-sectional profile illustrated in FIG. 10C and the rib waveguide cross-sectional profile illustrated in FIG. 10B is that the difference between the thickness of the strip section 1008 and the thickness of the planar section 1010 in the deep rib waveguide cross-sectional profile illustrated in FIG. 10C is less than the difference between the thickness of the strip section 1008 and the thickness of the planar section 1010 in the rib waveguide cross-sectional profile illustrated in FIG. 10B. The thickness of the planar section 1010 in the deep rib waveguide cross-sectional profile illustrated in FIG. 10C may be greater than the thickness of the planar section 1010 in the rib waveguide cross-sectional profile illustrated in FIG. 10B, and/or the thickness of the strip section 1008 in the deep rib waveguide cross-sectional profile illustrated in FIG. 10C may be less than the thickness of the strip section 1008 in the rib waveguide cross-sectional profile illustrated in FIG. 10B.

As indicated above, FIGS. 10A-10C are provided as examples. Other examples may differ from what is described with regard to FIGS. 10A-10C.

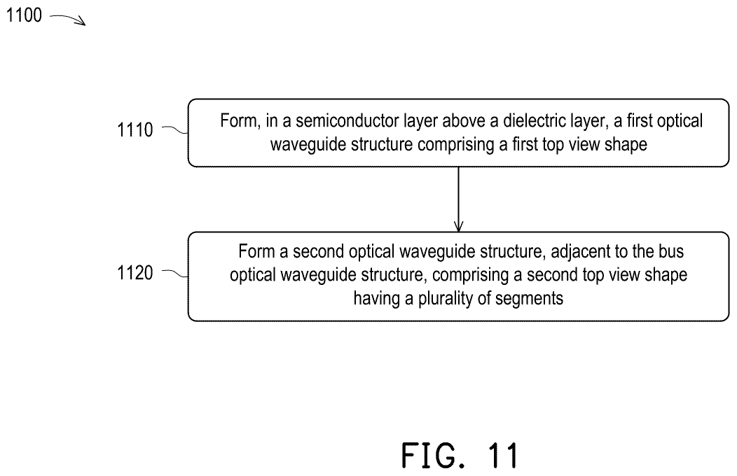

FIG. 11 is a flowchart of an example process 1100 associated with forming a semiconductor photonics device described herein. In some implementations, one or more process blocks of FIG. 11 are performed using one or more semiconductor processing tools, such as a deposition tool, an exposure tool, a developer tool, an etch tool, a planarization tool, an ion implantation tool, and/or a wafer/die transport tool, among other examples.

As shown in FIG. 11, process 1100 may include forming, in a semiconductor layer above a dielectric layer, a first optical waveguide structure comprising a first top view shape (block 1110). For example, one or more semiconductor processing tools may be used to form, in a semiconductor layer (e.g., a semiconductor layer 708, 808, and/or 908) above a dielectric layer (e.g., a dielectric layer 302, 402, 706, 806, 906, and/or 1004), a first optical waveguide structure (e.g., a bus optical waveguide structure 104) that has a first top view shape, as described herein.

As further shown in FIG. 11, process 1100 may include forming a second optical waveguide structure, adjacent to the first optical waveguide structure, that has a second top view shape having a plurality of segments (block 1120). For example, one or more semiconductor processing tools may be used to form a second optical waveguide structure (e.g., a closed-loop optical waveguide structure 102), adjacent to the first optical waveguide structure (e.g., the bus optical waveguide structure 104), that has a second top view shape having a plurality of segments 106, as described herein.

Process 1100 may include additional implementations, such as any single implementation or any combination of implementations described below and/or in connection with one or more other processes described elsewhere herein.

In a first implementation, a cross-section of the first optical waveguide structure (e.g., the closed-loop optical waveguide structure 102) is a strip waveguide cross section (e.g., the example implementation 1000 of a cross-sectional profile), a rib waveguide cross section (e.g., the example implementation 1006 of a cross-sectional profile), or a deep rib waveguide cross section (e.g., the example implementation 1012 of a cross-sectional profile).

In a second implementation, alone or in combination with the first implementation, the first top view shape is approximately symmetrical with at least a portion of the second top view shape.

In a third implementation, alone or in combination with one or more of the first and second implementations, the first top view shape substantially conforms to the second top view shape.

Although FIG. 11 shows example blocks of process 1100, in some implementations, process 1100 includes additional blocks, fewer blocks, different blocks, or differently arranged blocks than those depicted in FIG. 11. Additionally, or alternatively, two or more of the blocks of process 1100 may be performed in parallel.

In this way, a semiconductor photonics device includes a closed-loop optical waveguide structure having a top view size and/or shape that is configured to achieve a particular optical signal loss for the closed-loop optical waveguide structure. The closed-loop optical waveguide structure may be manufactured to have a polygonal top view shape in which the closed-loop optical waveguide structure includes a plurality of segments. The closed-loop optical waveguide structure may be manufactured to have a particular radius, to have a particular quantity of segments, and/or to have another attribute such that a particular optical signal loss is achieved for the closed-loop optical waveguide structure. Manufacturing the closed-loop optical waveguide structure to have a particular optical signal loss enables a Q factor for the closed-loop optical waveguide structure to be balanced with a power coupling coefficient for the closed-loop optical waveguide structure. This enables the closed-loop optical waveguide structure to achieve critical coupling (or to achieve near-critical coupling).

As described in greater detail above, some implementations described herein provide a semiconductor photonics device. The semiconductor photonics device includes a first optical waveguide structure. The semiconductor photonics device includes a second optical waveguide structure, adjacent to the first optical waveguide structure, having a polygonal top view shape having a plurality of segments.

As described in greater detail above, some implementations described herein provide a semiconductor photonics device. The semiconductor photonics device includes a first optical waveguide structure having a first top view shape that includes a plurality of first segments. The semiconductor photonics device includes a second optical waveguide structure, adjacent to the first optical waveguide structure, having a second top view shape that includes a plurality of second segments.

As described in greater detail above, some implementations described herein provide a method. The method includes forming, in a semiconductor layer above a dielectric layer, a first optical waveguide structure comprising a first top view shape. The method includes forming a second optical waveguide structure, adjacent to the first optical waveguide structure, comprising a second top view shape having a plurality of segments.

The terms “approximately” and “substantially” can indicate a value of a given quantity that varies within 5% of the value (e.g., +1%, +2%, +3%, +4%, +5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a first optical waveguide structure; and
a second optical waveguide structure, adjacent to the first optical waveguide structure, comprising a polygonal top view shape having a plurality of segments.

2. The semiconductor photonics device of claim 1, wherein the polygonal top view shape of the second optical waveguide structure comprises an approximately hexagonal top view shape, an approximately octagonal top view shape, or an approximately dodecagonal top view shape.

3. The semiconductor photonics device of claim 1, wherein all of the plurality of segments have approximately a same top view width.

4. The semiconductor photonics device of claim 1, wherein a first subset of the plurality of segments has a first top view width;
wherein a second subset of the plurality of segments has a second top view width; and
wherein the first top view width is greater than the second top view width.

5. The semiconductor photonics device of claim 1, wherein all of the plurality of segments have approximately a same top view length.

6. The semiconductor photonics device of claim 1, wherein a first subset of the plurality of segments has a first top view length;
wherein a second subset of the plurality of segments has a second top view length; and
wherein the first top view length is greater than the second top view length.

7. The semiconductor photonics device of claim 1, wherein a material composition of the first optical waveguide structure and a material composition of the second optical waveguide structure are approximately a same material composition.

8. The semiconductor photonics device of claim 1, wherein a material composition of the first optical waveguide structure and a material composition of the second optical waveguide structure are different material compositions.

9. The semiconductor photonics device of claim 1, wherein the first optical waveguide structure is vertically adjacent to the second optical waveguide structure.

10. The semiconductor photonics device of claim 1, wherein the first optical waveguide structure is laterally adjacent to the second optical waveguide structure.

11. A semiconductor photonics device, comprising:
a first optical waveguide structure comprising a first top view shape having a plurality of first segments; and
a second optical waveguide structure, adjacent to the first optical waveguide structure, comprising a second top view shape having a plurality of second segments.

12. The semiconductor photonics device of claim 11, wherein the first top view shape is approximately symmetrical with at least a portion of the second top view shape.

13. The semiconductor photonics device of claim 11, wherein an intersection point, between two segments of the plurality of second segments of the second optical waveguide structure, is adjacent to an intersection point between two segments of the plurality of first segments of the first optical waveguide structure.

14. The semiconductor photonics device of claim 11, wherein an intersection point, between two segments of the plurality of first segments of the first optical waveguide structure, is adjacent to a segment of the plurality of second segments of the second optical waveguide structure.

15. The semiconductor photonics device of claim 11, wherein a segment of the plurality of second segments of the second optical waveguide structure is adjacent to a segment of the plurality of first segments of the first optical waveguide structure.

16. The semiconductor photonics device of claim 15, wherein the first top view shape substantially conforms to the second top view shape.

17. A method, comprising:
forming, in a semiconductor layer above a dielectric layer, a first optical waveguide structure comprising a first top view shape; and
forming a second optical waveguide structure, adjacent to the first optical waveguide structure, comprising a second top view shape having a plurality of segments.

18. The method of claim 17, wherein a cross section of the second optical waveguide structure is a strip waveguide cross section, a rib waveguide cross section, or a deep rib waveguide cross section.

19. The method of claim 17, wherein the first top view shape is approximately symmetrical with at least a portion of the second top view shape.

20. The method of claim 17, wherein the first top view shape substantially conforms to the second top view shape.
